(19) United States
(12) Patent Application Publication
(10) Pub. No.: US 2025/0150924 A1
(43) Pub. Date: May 8, 2025

(54) CONDITIONAL HANDOVER EXECUTION CONDITION INDICATION

(71) Applicant: QUALCOMM Incorporated, San Diego, CA (US)

(72) Inventors: Hung Dinh LY, San Diego, CA (US); Sherif ELAZZOUNI, San Diego, CA (US)

(21) Appl. No.: 18/675,899

(22) Filed: May 28, 2024

Related U.S. Application Data
(60) Provisional application No. 63/595,603, filed on Nov. 2, 2023.

(51) Int. Cl. H04W 36/36; H04W 52/02; H04W 76/28

(52) U.S. Cl. CPC H04W 36/362; H04W 52/0235; H04W 76/28

(57) ABSTRACT

Methods, systems, and devices for wireless communications are described. The described techniques provide for a network entity to indicate a network energy savings (NES) mode status for one or more cells in a common control message sent to a group of user equipments (UEs). The network entity may include one or more NES mode indications in a downlink control information (DCI) message that activates or deactivates a discontinuous transmission (DTX) configuration, a discontinuous reception (DRX) configuration, or both for one or more cells. The DCI message may include the DTX and the DRX information in one or more respective information blocks corresponding one or more serving cells for the group of UEs, and the network entity may include the one or more NES mode indications in the one or more information blocks.

### CROSS REFERENCE

The present Application for Patent claims the benefit of U.S. Provisional Patent Application No. 63/595,603 by LY et al., entitled “CONDITIONAL HANDOVER EXECUTION CONDITION INDICATION,” filed Nov. 2, 2023, assigned to the assignee hereof, and expressly incorporated by reference herein.

### FIELD OF TECHNOLOGY

The following relates to wireless communications, including conditional handover execution condition indication.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

Some wireless communications may support handover procedures, which may involve a UE switching from a connection with a source node to a connection with a target node (such as if the UE may experience improved communications via the target node). In some cases, such a handover procedure may be an example of a conditional handover (CHO) procedure, where the UE may be configured to monitor for a CHO execution condition and perform the CHO (e.g., autonomously) upon identifying that the CHO execution condition has been met.

### SUMMARY

The described techniques relate to improved methods, systems, devices, and apparatuses that support conditional handover execution condition indication. For example, the described techniques provide for a network entity to indicate a network energy savings (NES) mode status for one or more cells in a common control message sent to a group of user equipments (UEs). For example, the network entity may include one or more NES mode indications in a downlink control information (DCI) message that activates or deactivates a discontinuous transmission (DTX) configuration (e.g., via a value of a first bit), a discontinuous reception (DRX) configuration (e.g., via a value of a second bit), or both for one or more cells. The DCI message may include the DTX and the DRX information in one or more respective information blocks corresponding to one or more serving cells for the group of UEs, and the network entity may include the one or more NES mode indications in the one or more information blocks. For example, a first information block corresponding to a first cell may include an additional indication of whether the first cell is operating in an NES mode or a non-NES mode. Alternatively, the network entity may include an indication of the NES mode for the first cell in another information block, which may be an information block associated with another cell or an additional information block including NES status indications for each of the one or more cells.

A method for wireless communications by a first UE is described. The method may include receiving a control message common to a set of multiple UEs including at least the first UE, the control message including a set of multiple information blocks corresponding to a set of multiple cells, where: one or more information blocks of the set of multiple information blocks include one or more first indications providing a DTX configuration, a DRX configuration, or both for one or more cells of the set of multiple cells; and at least a first information block of the set of multiple information blocks includes a second indication indicating an NES mode of a first cell of the set of multiple cells, the first cell including a primary cell for the first UE, monitoring a wireless channel for a conditional handover execution condition based on the NES mode of the primary cell indicated by the second indication, and performing a conditional handover (CHO) procedure based on monitoring for the CHO execution condition.

A first UE for wireless communications is described. The first UE may include one or more memories storing processor executable code, and one or more processors coupled with the one or more memories. The one or more processors may individually or collectively operable to execute the code to cause the first UE to receive a control message common to a set of multiple UEs including at least the first UE, the control message including a set of multiple information blocks corresponding to a set of multiple cells, where: one or more information blocks of the set of multiple information blocks include one or more first indications providing a DTX configuration, a DRX configuration, or both for one or more cells of the set of multiple cells; and at least a first information block of the set of multiple information blocks includes a second indication indicating an NES mode of a first cell of the set of multiple cells, the first cell including a primary cell for the first UE, monitor a wireless channel for a CHO execution condition based on the NES mode of the primary cell indicated by the second indication, and perform a CHO procedure based on monitoring for the CHO execution condition.

Another first UE for wireless communications is described. The first UE may include means for receiving a control message common to a set of multiple UEs including at least the first UE, the control message including a set of multiple information blocks corresponding to a set of multiple cells, where: one or more information blocks of the set of multiple information blocks include one or more first indications providing a DTX configuration, a DRX configuration, or both for one or more cells of the set of multiple cells; and at least a first information block of the set of multiple information blocks includes a second indication indicating an NES mode of a first cell of the set of multiple cells, the first cell including a primary cell for the first UE, means for monitoring a wireless channel for a CHO execution condition based on the NES mode of the primary cell indicated by the second indication, and means for performing a CHO procedure based on monitoring for the CHO execution condition.

A non-transitory computer-readable medium storing code for wireless communications is described. The code may include instructions executable by a processor to receive a control message common to a set of multiple UEs including at least the first UE, the control message including a set of multiple information blocks corresponding to a set of multiple cells, where: one or more information blocks of the set of multiple information blocks include one or more first indications providing a DTX configuration, a DRX configuration, or both for one or more cells of the set of multiple cells; and at least a first information block of the set of multiple information blocks includes a second indication indicating an NES mode of a first cell of the set of multiple cells, the first cell including a primary cell for the first UE, monitor a wireless channel for a CHO execution condition based on the NES mode of the primary cell, and perform a CHO procedure based on monitoring for the CHO execution condition.

In some examples of the method, first UEs, and non-transitory computer-readable medium described herein, monitoring the wireless channel for the CHO execution condition may include operations, features, means, or instructions for monitoring for a first CHO execution condition based on the second indication indicating that the first cell operates in the NES mode, the first CHO execution condition associated with the NES mode and monitoring for a second CHO execution condition based on the second indication indicating that the first cell operates in a non-NES mode, the second CHO execution condition associated with the non-NES mode.

Some examples of the method, first UEs, and non-transitory computer-readable medium described herein may further include operations, features, means, or instructions for receiving, via the first information block, a first indication of the DTX configuration, the DRX configuration, or both for the first cell, where the first information block includes the second indication.

In some examples of the method, first UEs, and non-transitory computer-readable medium described herein, the second indication may be located in a second bit position that may be after a first bit position corresponding to the first indication within the first information block.

In some examples of the method, first UEs, and non-transitory computer-readable medium described herein, the second indication may be located in a second bit position that may be before a first bit position corresponding to the first indication within the first information block.

Some examples of the method, first UEs, and non-transitory computer-readable medium described herein may further include operations, features, means, or instructions for receiving a second control message including a bit position of the second indication within the control message, where the bit position indicates that the second indication may be included in a second information block of the set of multiple information blocks.

In some examples of the method, first UEs, and non-transitory computer-readable medium described herein, the second information block includes both of the second indication and a first indication of the DTX configuration, the DRX configuration, or both for a second cell of the set of multiple cells.

In some examples of the method, first UEs, and non-transitory computer-readable medium described herein, the second information block includes a set of multiple third indications providing a respective NES mode associated with the set of multiple cells, the set of multiple third indications including at least the second indication indicating the NES mode of a first cell.

Some examples of the method, first UEs, and non-transitory computer-readable medium described herein may further include operations, features, means, or instructions for receiving, via a second information block of the one or more information blocks, a third indication indicating an NES mode of a second cell of the set of multiple cells, where the second cell may be a candidate target cell for the first UE and a primary cell for a second UE of the set of multiple UEs.

In some examples of the method, first UEs, and non-transitory computer-readable medium described herein, performing the CHO procedure may include operations, features, means, or instructions for establishing a connection with the second cell based on the second indication indicating that the first cell may be operating in the NES mode and the third indication indicating that the second cell may be operating in a non-NES mode.

Some examples of the method, first UEs, and non-transitory computer-readable medium described herein may further include operations, features, means, or instructions for removing the second cell from a list of candidate target cells based on the third indication indicating that the second cell may be operating in the NES mode.

In some examples of the method, first UEs, and non-transitory computer-readable medium described herein, the second indication includes a set of multiple bits and a first bit of the set of multiple bits indicates the NES mode of the first cell and one or more second bits of the set of multiple bits activate one or more respective CHO configurations for the first UE.

Some examples of the method, first UEs, and non-transitory computer-readable medium described herein may further include operations, features, means, or instructions for transitioning, at a first time, between monitoring for a first CHO execution condition and a second condition handover execution condition based on the second indication indicating that the first cell may have transitioned between the NES mode and a non-NES mode, where the first time follows reception of the control message by a value corresponding to a duration.

In some examples of the method, first UEs, and non-transitory computer-readable medium described herein, the duration may be identified according to a subcarrier spacing associated with the control message.

A method for wireless communications by a first network entity is described. The method may include communicating with a second network entity to establish a CHO configuration for at least a first UE and transmitting, to a set of multiple UEs including at least the first UE, a common control message including a set of multiple information blocks corresponding to a set of multiple cells, where: one or more information blocks of the set of multiple information blocks include one or more first indications providing a DTX configuration, a DRX configuration, or both for one or more cells of the set of multiple cells; and at least a first information block of the set of multiple information blocks includes a second indication indicating an NES mode of a first cell of the set of multiple cells, the first cell including a primary cell for the first UE.

A first network entity for wireless communications is described. The first network entity may include one or more memories storing processor executable code, and one or more processors coupled with the one or more memories. The one or more processors may individually or collectively operable to execute the code to cause the first network entity to communicate with a second network entity to establish a CHO configuration for at least a first UE and transmit, to a set of multiple UEs including at least the first UE, a common control message including a set of multiple information blocks corresponding to a set of multiple cells, where: one or more information blocks of the set of multiple information blocks include one or more first indications providing a DTX configuration, a DRX configuration, or both for one or more cells of the set of multiple cells; and at least a first information block of the set of multiple information blocks includes a second indication indicating an NES mode of a first cell of the set of multiple cells, the first cell including a primary cell for the first UE.

Another first network entity for wireless communications is described. The first network entity may include means for communicating with a second network entity to establish a CHO configuration for at least a first UE and means for transmitting, to a set of multiple UEs including at least the first UE, a common control message including a set of multiple information blocks corresponding to a set of multiple cells, where: one or more information blocks of the set of multiple information blocks include one or more first indications providing a DTX configuration, a DRX configuration, or both for one or more cells of the set of multiple cells; and at least a first information block of the set of multiple information blocks includes a second indication indicating an NES mode of a first cell of the set of multiple cells, the first cell including a primary cell for the first UE.

A non-transitory computer-readable medium storing code for wireless communications is described. The code may include instructions executable by a processor to communicate with a second network entity to establish a CHO configuration for at least a first UE and transmit, to a set of multiple UEs including at least the first UE, a common control message including a set of multiple information blocks corresponding to a set of multiple cells, where: one or more information blocks of the set of multiple information blocks include one or more first indications providing a DTX configuration, a DRX configuration, or both for one or more cells of the set of multiple cells; and at least a first information block of the set of multiple information blocks includes a second indication indicating an NES mode of a first cell of the set of multiple cells, the first cell including a primary cell for the first UE.

Some examples of the method, first network entities, and non-transitory computer-readable medium described herein may further include operations, features, means, or instructions for transmitting, via the first information block, a first indication of the DTX configuration, the DRX configuration, or both for the first cell, where the first information block includes the second indication.

In some examples of the method, first network entities, and non-transitory computer-readable medium described herein, the second indication may be located in a second bit position that may be after a first bit position corresponding to the first indication within the first information block.

In some examples of the method, first network entities, and non-transitory computer-readable medium described herein, the second indication may be located in a second bit position that may be before a first bit position corresponding to the first indication within the first information block.

Some examples of the method, first network entities, and non-transitory computer-readable medium described herein may further include operations, features, means, or instructions for transmitting a second control message including a bit position of the second indication within the control message, where the bit position indicates that the second indication may be included in a second information block of the set of multiple information blocks.

In some examples of the method, first network entities, and non-transitory computer-readable medium described herein, the second information block includes both of the second indication and a first indication of the DTX configuration, the DRX configuration, or both for a second cell of the set of multiple cells.

In some examples of the method, first network entities, and non-transitory computer-readable medium described herein, the second information block includes a set of multiple third indications providing a respective NES mode associated with the set of multiple cells, the set of multiple third indications including at least the second indication indicating the NES mode of a first cell.

Some examples of the method, first network entities, and non-transitory computer-readable medium described herein may further include operations, features, means, or instructions for transmitting, via a second information block of the one or more information blocks, a third indication indicating an NES mode of a second cell of the set of multiple cells, where the second cell may be a candidate target cell for the first UE and a primary cell for a second UE of the set of multiple UEs.

In some examples of the method, first network entities, and non-transitory computer-readable medium described herein, the second indication includes a set of multiple bits and a first bit of the set of multiple bits indicates the NES mode of the first cell and one or more second bits of the set of multiple bits activate one or more respective CHO configurations for the first UE.

### BRIEF DESCRIPTION OF THE DRAWINGS

FIG. 1 shows an example of a wireless communications system that supports conditional handover (CHO) execution condition indication in accordance with one or more aspects of the present disclosure.

FIG. 2 shows an example of a wireless communications system that supports CHO execution condition indication in accordance with one or more aspects of the present disclosure.

FIGS. 3A and 3B show examples of control message configurations that support CHO execution condition indication in accordance with one or more aspects of the present disclosure.

FIG. 4 shows an example of a process flow that supports CHO execution condition indication in accordance with one or more aspects of the present disclosure.

FIGS. 5 and 6 show block diagrams of devices that support CHO execution condition indication in accordance with one or more aspects of the present disclosure.

FIG. 7 shows a block diagram of a communications manager that supports CHO execution condition indication in accordance with one or more aspects of the present disclosure.

FIG. 8 shows a diagram of a system including a device that supports CHO execution condition indication in accordance with one or more aspects of the present disclosure.

FIGS. 9 and 10 show block diagrams of devices that support CHO execution condition indication in accordance with one or more aspects of the present disclosure.

FIG. 11 shows a block diagram of a communications manager that supports CHO execution condition indication in accordance with one or more aspects of the present disclosure.

FIG. 12 shows a diagram of a system including a device that supports CHO execution condition indication in accordance with one or more aspects of the present disclosure.

FIGS. 13 and 14 show flowcharts illustrating methods that support CHO execution condition indication in accordance with one or more aspects of the present disclosure.

### DETAILED DESCRIPTION

Wireless communications systems may support conditional handover (CHO) procedures to manage connections between one or more wireless devices. For example, a user equipment (UE) may be configured to monitor for one or more CHO execution conditions to determine whether to maintain an established connection with a source cell (e.g., a source node) or to establish a new connection with a target cell (e.g., a target node). In some cases, such CHO execution conditions may depend on a network energy savings (NES) mode of a cell. As an example, the UE may monitor for a first set of CHO execution conditions while the source cell operates in a non-NES mode and may monitor for a second set of CHO execution conditions (e.g., NES-specific CHO execution conditions) while the source cell operates in an NES mode. However, the UE may be unaware of whether the source cell is operating in the NES mode or the non-NES mode, may be unaware of whether one or more candidate target cells are operating in the NES mode or the non-NES mode, or both, which may limit an ability of the UE to perform a CHO procedure according to the correct CHO execution condition.

To indicate an NES mode status of one or more cells, a network entity may include one or more indications of whether the one or more cells are operating in the NES mode or the non-NES mode in a common control message sent to a group of UEs. For example, the network entity may include the one or more indications in a downlink control information (DCI) message that activates or deactivates a discontinuous transmission (DTX) configuration (e.g., via a value of a first bit), a discontinuous reception (DRX) configuration (e.g., via a value of a second bit), or both for one or more cells. The DCI message may include respective DTX/DRX configurations (which may refer to an indication including the first bit toggling the DTX configuration, the second bit toggling the DRX configuration, or both) for each respective cell in one or more information blocks. For example, a first information block may indicate the DTX/DRX configuration for a first cell (e.g., cell identifier (ID) A), a second information block may indicate the DTX/DRX configuration for a second cell (e.g., cell ID B), and so on. In some cases, the network entity may include one or more bits in the information blocks to indicate the NES status of one or more corresponding cells. For example, the first information block may include an additional bit (e.g., in addition to the DTX/DRX configuration bits) indicating whether the first cell is operating in the NES mode. Alternatively, the network entity may include an indication for the first cell in another information block, which may be an information block associated with another cell or an additional information block including NES status indications for each of the one or more cells. Such techniques may improve CHO procedures in the wireless network by providing a mechanism for the UE to determine a proper CHO execution condition for a source cell of the UE.

Aspects of the disclosure are initially described in the context of wireless communications systems. Aspects of the disclosure are further illustrated by and described with reference to control message configurations and a process flow. Aspects of the disclosure are further illustrated by and described with reference to apparatus diagrams, system diagrams, and flowcharts that relate to CHO execution condition indication.

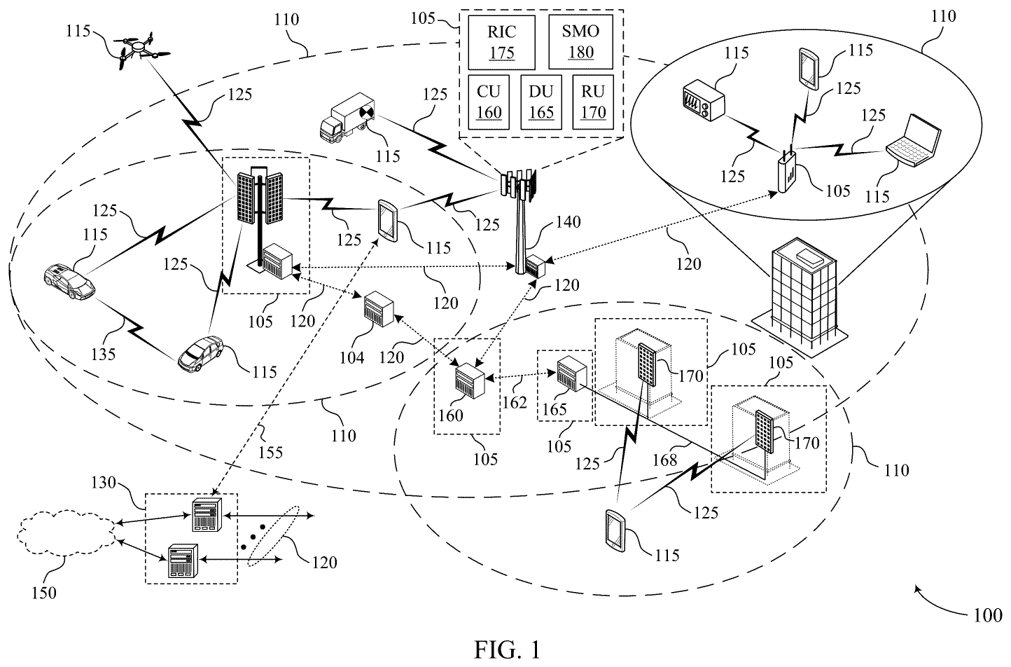

FIG. 1 shows an example of a wireless communications system 100 that supports CHO execution condition indication in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support CHO execution condition indication as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1: M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

In some examples of the wireless communications system 100, a UE 115 may be configured to perform a CHO procedure to switch from a connection with a primary cell to a connection with a candidate target cell. For example, a source node (e.g., a network entity 105, a first cell, or the like) may transmit a CHO configuration message to the UE 115 indicating one or more CHO execution conditions. The UE 115 may monitor for the one or more CHO execution conditions and may execute the CHO upon identifying that a CHO execution condition was met (e.g., if any combination of the one or more CHO execution conditions has been satisfied). In some cases, such CHO execution conditions may depend on an NES mode of the primary cell. As an example, the UE 115 may monitor for a first set of CHO execution conditions while the primary cell operates in a non-NES mode and may monitor for a second set of CHO execution conditions (e.g., NES-specific CHO execution conditions) while the primary cell operates in an NES mode. However, the UE 115 may be unaware of whether the primary cell is operating in the NES mode or the non-NES mode, may be unaware of whether one or more candidate target cells are operating in the NES mode or the non-NES mode, or both, which may limit an ability of the UE 115 to perform a CHO procedure according to the correct CHO execution condition.

To indicate an NES mode status of one or more cells, a network entity 105 may include one or more indications of whether the one or more cells are operating in the NES mode or the non-NES mode in a common control message sent to a group of UEs 115. For example, the network entity may include the one or more indications in a DCI message that activates or deactivates a DTX configuration (e.g., via a value of a first bit), a DRX configuration (e.g., via a value of a second bit), or both for one or more cells. The DCI message may include respective DTX/DRX configurations (which may refer to an indication including the first bit toggling the DTX configuration, the second bit toggling the DRX configuration, or both) for each respective cell in one or more information blocks. For example, a first information block may indicate the DTX/DRX configuration for a first cell (e.g., cell ID A), a second information block may indicate the DTX/DRX configuration for a second cell (e.g., cell ID B), and so on. In some cases, the network entity 105 may include one or more bits in the information blocks to indicate the NES status of one or more corresponding cells. For example, the first information block may include an additional indication (e.g., one or more bits in addition to the DTX/DRX configuration bits) indicating whether the first cell is operating in the NES mode. Alternatively, the network entity 105 may include an indication for the first cell in another information block, which may be an information block associated with another cell or an additional information block including NES status indications for each of the one or more cells. Such techniques may improve CHO procedures in the wireless network by providing a mechanism for the UE 115 to determine a proper CHO execution condition for a primary cell of the UE 115.

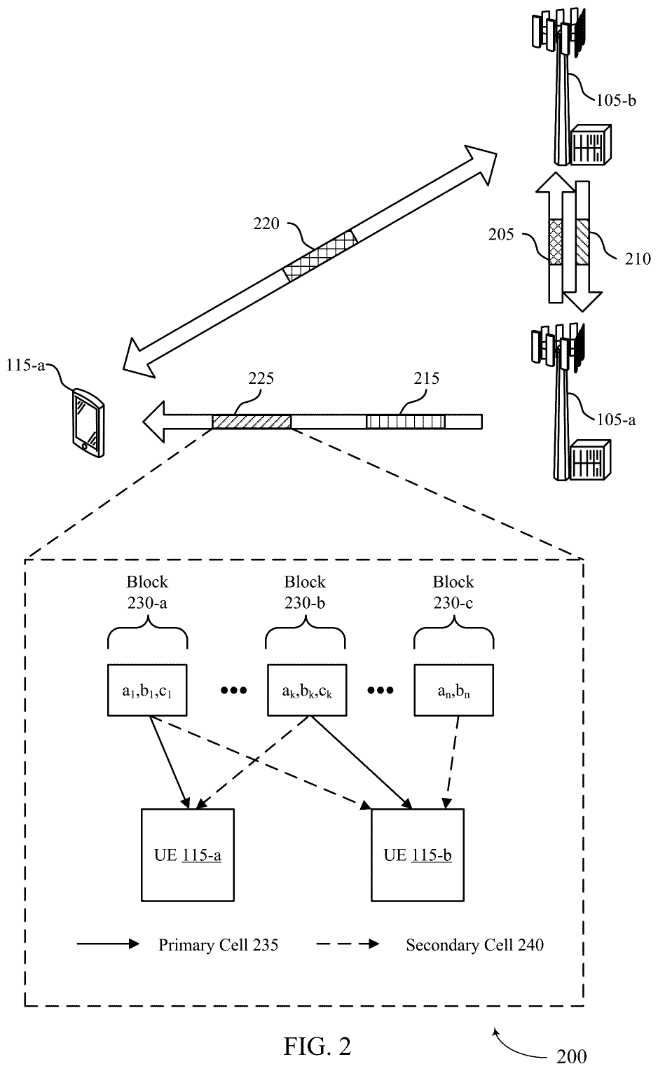

FIG. 2 shows an example of a wireless communications system 200 that supports CHO execution condition indication in accordance with one or more aspects of the present disclosure. The wireless communications system 200 may implement, or be implemented by, one or more aspects of the wireless communications system 100. For example, the wireless communications system 200 may include communications between a network entity 105-a, a network entity 105-b, and a UE 115-a, which may be examples of corresponding devices described with reference to FIG. 1. In some cases, the wireless communications system 200 may support the UE 115-a executing a CHO procedure, which may include the UE 115-a switching from a connection with the network entity 105-a (e.g., a primary cell) to a connection with the network entity 105-b (e.g., a target cell) upon identifying that a CHO execution condition was met. It should be noted that while the example illustrated by the wireless communications system 200 shows the UE 115-a performing the CHO procedure between two network entities 105, techniques described herein may be applicable to any handover or CHO procedure, such as the UE 115-a transitioning connections between multiple cells supported by a single network entity 105, a combination of wireless nodes of the wireless network, or any combination thereof.

In some cases, the network entity 105-a and the network entity 105-b may establish a CHO configuration via a wireless link between the network entity 105-a and the network entity 105-b (e.g., a wireless backhaul link or any other wireless connection between network nodes). For example, the network entity 105-a may transmit, to the network entity 105-b, a CHO request message 205 indicating a request for one or more neighbor cells of the network entity 105-b (e.g., one or more candidate cells belonging to the network entity 105-b) to act as target cells for the UE 115-a. The network entity 105-b may respond to the CHO request message 205 with a CHO response message 210, which may indicate acceptance of the CHO request (e.g., CHO request acknowledgment (ACK)) and a CHO configuration for the target cells (e.g., via a RRCReconfiguration*). In some cases, the CHO configuration for the target cells may indicate one or more CHO execution conditions.

In some cases, after establishing the CHO configuration with the network entity 105-b, the network entity 105-a may transmit a CHO configuration message 215 to the UE 115-a. The CHO configuration message 215 may indicate one or more CHO execution conditions (e.g., events) for the UE 115-a to monitor for and the CHO configuration for the target cells (e.g., the RRCReconfiguration*). In some examples, the CHO execution conditions may indicate that the UE 115-a is to monitor for a first condition (e.g., event A1) corresponding to a serving cell quality satisfying a threshold, a second condition (e.g., event A2) corresponding to a serving cell quality failing to satisfy a threshold, a third condition (e.g., event A3) corresponding to a neighbor cell quality being offset from a special cell (which may refer to a primary cell, or in dual connectivity operation a primary cell in a main cell group (MCG) or a primary or secondary cell of a secondary cell group (SCG)) quality by a threshold, a fourth condition (e.g., event A4) corresponding to a neighbor cell quality satisfying a threshold, a fifth condition (e.g., event A5) corresponding to a special cell quality failing to satisfy a first threshold and a neighbor cell quality satisfying a second threshold, a sixth condition (e.g., event A6) corresponding to a neighbor cell quality being offset from a serving cell quality by a threshold, or any combination thereof, among other examples.

As an example, the CHO configuration message 215 may include two conditions (e.g., events A3 and A5) and candidate target cells and indicate values corresponding to CHO execution for these conditions and specified target cells (e.g., where the primary cell for the UE 115-a is considered the serving cell and special cell and the specified target cells are considered the neighbor cells). In some cases, the UE 115-a may monitor the primary cell of network entity 105-a and the candidate target cells of the network entity 105-b to identify whether the CHO execution conditions have been met. Upon identifying that a CHO execution condition has been met, the UE 115-a may execute the CHO procedure (e.g., autonomously) and may switch to a connection with a target cell of the network entity 105-b (e.g., via a CHO confirmation message 220), and the network entity 105-b may complete the CHO procedure by communicating path switch and UE context release messages with the network entity 105-a.

In some examples, the CHO execution conditions may depend on whether the primary cell and the target cells operate in an NES mode. For example, while operating in the NES mode, the network entity 105-a may modify communication parameters (e.g., changing logical or physical antenna entity parameters) to support power savings, which may affect threshold values or events associated with the CHO execution conditions. In some cases, one or more CHO execution conditions may be configured as CHO execution conditions in the NES mode (e.g., events A3, A4, and A5), and the CHO configuration message 215 may indicate how such CHO execution conditions are modified according to the NES mode of the primary and target cells. However, the UE 115-a may be unaware of whether the cells are operating in the NES mode or a non-NES mode (e.g., such as when the cells dynamically switch between operation modes), which may limit a capability of the UE 115-a to perform the CHO procedure according to the correct CHO execution condition. Additionally, the network entity 105-a may be unable to indicate NES mode status for one or multiple serving cells of multiple UEs 115 (e.g., due to overhead incurred from multiple individual messages).

To support indicating the NES mode status of one or multiple serving cells, the network entity 105-a may include one or more indications of whether the one or multiple serving cells are operating in the NES mode or the non-NES mode in a common control message sent to a group of UEs 115 including at least the UE 115-a and a UE 115-b. For example, the network entity 105-a may include the NES mode indications in a control message that activates a DTX configuration, a DRX configuration, or both for the one or multiple serving cells.

The UEs 115 may identify the DTX/DRX configurations via an RRC message or a group common DCI message. For example, for an RRC based indication, the network entity 105-a may transmit an RRC message activating the DTX/DRX configurations for a cell during an RRC configuration for the cell and may transmit an RRC message deactivating the DTX/DRX configurations for the cell upon releasing the RRC configuration. Alternatively, for a group common DCI based indication, the network entity 105-a may transmit a DCI message 225 (e.g., having a DCI having format 2_9 common to multiple UEs 115) activating or deactivating the DTX/DRX configuration for one or more serving cells. For example, the UE 115-a may monitor a serving cell for the DCI message 225 and may apply the DTX/DRX configuration for the serving cell (e.g., indicated by a corresponding information block 230) within a threshold duration of receiving the DCI message 225 (e.g., within 3 ms).

The DCI message 225 may include a set of information blocks 230 indicating respective DTX/DRX configurations corresponding to the one or multiple serving cells. For example, the DCI message 225 may include a first information block 230-a corresponding to a first cell (e.g., cell ID A) that includes a first bit (e.g., bit a₁) toggling a DTX configuration for the first cell, a second bit (e.g., bit b₁) toggling a DRX configuration for the first cell, or both. The DCI message 225 may include similar information blocks to indicate the DTX/DRX configuration for other serving cells, such as a second information block 230-b indicating the DTX/DRX configuration for a second cell (e.g., DTX/DRX information for cell ID B via bits aₖ, bₖ, or both), a third information block 230-c indicating the DTX/DRX configuration for a third cell (e.g., DTX/DRX information for cell ID C via bits aₙ, bₙ, or both), or any combination thereof.

In some cases, such as when carrier aggregation is configured for a UE 115, the UE 115 may be configured with one or multiple serving cells, and the UE 115 may monitor the DTX/DRX configuration for the one or multiple serving cells. Additionally, or alternatively, a DTX/DRX configuration of a serving cell may be configured for a subset of the one or multiple serving cells (e.g., a single information block 230 may indicate a DTX/DRX configuration for one or multiple serving cells). In some examples, the network entity 105-a may transmit, to the UEs 115, a first parameter (e.g., positionInDCI-cellDTRX) indicating the starting position of each information block 230 to support the UEs 115 identifying the DTX/DRX configurations for each serving cell. Additionally, the network entity 105-b may transmit a second parameter indicating the serving cell IDs that correspond to the starting position of each information block 230 (e.g., a one-to-one correspondence).

In some cases, the DTX/DRX configurations may inform the UEs 115 of periodic durations during which the UEs 115 should or should not perform communications (e.g., switching between an active time and a non-active time according to a cycle). For example, if the UE 115-a identifies that the DTX configuration of the first cell is activated (e.g., indicated via bit a₁ of the information block 230-a), the UE 115-a may refrain from transmitting for one or more uplink transmissions during one or more periodic durations (e.g., non-active transmission times). Such uplink transmissions may include a configured grant (CG) transmission, a scheduling request (SR), a periodic or semi-persistent sounding reference signal (SRS) (which may exclude SRSs used for positioning), a periodic or semi-persistent CSI report, or any combination thereof. Similarly, if the UE 115-a identifies that the DRX configuration of the first cell is activated (e.g., indicated via bit a₂ of the information block 230-a), the UE 115-a may refrain from monitoring for one or more downlink transmissions during one or more periodic durations (e.g., non-active reception times). Such downlink transmissions may include a semi-persistently scheduled (SPS) transmission, a UE-specific search space (USS) physical downlink control channel (PDCCH) transmission, a PDCCH transmission with one or more DCI formats (e.g., DCI format 2_X, where X=0, 1, 2, 3, or 5), a periodic or semi-persistent channel state information reference signal (CSI-RS) for CSI reporting (e.g., including a rank indicator (RI)), or any combination thereof.

In some examples, the network entity 105-a may include one or more indications of whether one or more serving cells are operating in an NES mode or a non-NES mode in the DCI message 225. In some cases, the network entity 105-a may include the one or more indications in the information blocks 230 to indicate the NES mode for a corresponding serving cell. For example, the network entity 105-a may include a one-bit indication of an NES mode for the first cell (e.g., cell ID A) in the information block 230-a in addition to the DTX/DRX configuration bits (e.g., bit c₁ in addition to bits a₁, b₁, or both). In some cases, if the first cell is a primary cell 235 for the UE 115-a, the UE 115-a may identify the NES mode of the first cell according to the NES mode indication in the information block 230-a. For example, the UE 115-a may identify that the first cell has entered the NES mode according to a first value of the indication (e.g., binary value ‘1’) and may identify that the first cell has entered the non-NES mode according to a second value of the indication (e.g., binary value ‘0’). Similarly, the network entity 105-a may include a one-bit indication of an NES mode for the second cell (e.g., cell ID B) in the information block 230-b in addition to the DTX/DRX configuration bits (e.g., bit cₖ in addition to bits aₖ, bₖ, or both). In some cases, if the second cell is a primary cell 235 for the UE 115-b, the UE 115-b may identify the NES mode of the second cell according to the NES mode indication in the information block 230-c. Upon identifying that a primary cell 235 has transitioned between the NES mode and the non-NES mode, a UE 115 may transition between monitoring for an NES-specific CHO execution condition and a non-NES-specific CHO execution condition. In some cases, the UE 115 may perform such a transition after a duration following reception of the DCI message 225 (e.g., 3 ms or another configured duration).

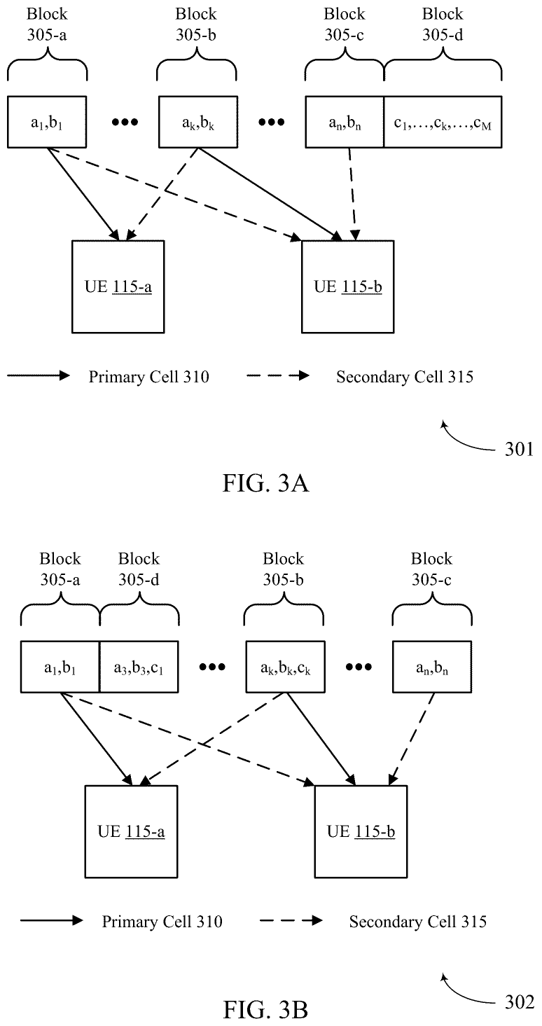

In some examples, the NES mode indication may be located, within an information block 230, before or after the DTX/DRX configuration bits. As a first example, the information block 230-a may include the NES mode indication in a second bit position that is after a first bit position of the DTX/DRX configuration bits (e.g., in the order of a₁, b₁, c₁). As a second example, the information block 230-a may include the NES mode indication in a second bit position that is before a first bit position of the DTX/DRX configuration bits (e.g., in an order of c₁, a₁, b₁). Alternatively, the network entity 105-a may include an NES mode indication for the first cell (e.g., c₁) in another information block 230 that is not associated with the first cell (e.g., an information block besides the information block 230-a). For example, the NES mode indication may be included in an additional information block 230 that includes NES mode indications for each serving cell, as described further with reference to FIG. 3A. As another example, the NES mode indication may be included in an information block 230 indicating a DTX/DRX configuration for another serving cell, as described further with reference to FIG. 3B. In such examples, the network entity 105-a may indicate a position of the NES mode indication within the DCI message 225 via a parameter (e.g., positionInDCI-nesMode).

In some examples, different UEs 115 may be configured with different primary cells 235. For example, the first cell with cell ID A may be configured as a primary cell 235 for the UE 115-a and the second cell with cell ID B may be configured as a primary cell 235 for the UE 115-b. In some examples, the CHO configuration message 215 (e.g., an RRC configuration) may configure the UE 115-a with one or more candidate target cells. For example, the CHO configuration message 215 may indicate that the second cell with cell ID B is a secondary cell 240 for the UE 115-a (e.g., while also being a primary cell 235 for the UE 115-b). The network entity 105-a may indicate the NES mode for target cells using an RRC configuration (e.g., a CHO reconfiguration) or via the DCI message 225 (e.g., dynamically indicated). For example, the UE 115-a may identify the NES mode for the second cell based on identifying the value of cₖ in the information block 230-b. In some cases, the UE 115-a may remove the second cell from a list of candidate target cells if the UE 115-a identifies the second cell has entered the NES mode (e.g., the second cell is no longer considered a candidate target cell until leaving the NES mode).

In some cases, when a UE 115 is configured with one target cell, the network entity 105-a may refrain from transitioning the target cell into the NES mode (e.g., to avoid the UE 115 having no candidate cells operating in the non-NES mode). For example, if the second cell is the only secondary cell 240 configured for the UE 115-a, the network entity 105-a may refrain from transitioning the second cell to the NES mode. Alternatively, if a UE 115 is configured with multiple candidate target cells, the network entity 105-a may allow one or more of the multiple candidate target cells to enter the NES mode. For example, if the UE 115-b is configured with both the first cell and the third cell as secondary cells 240 and the second cell as the primary cell 235, the network entity 105-a may allow one or more of the first cell, the second cell, or the third cell to enter the NES mode (e.g., as long as the UE 115-b still has one connected cell operating in the non-NES mode).

In some cases, the NES mode indications included in the DCI message 225 (e.g., c₁, cₖ, or the like) may further include one or more bits activating or deactivating one or more CHO configurations. For example, the UE 115-a may be configured with multiple NES-CHO execution configurations or conditions (e.g., in addition to a standard CHO condition). As an example, a first configuration or condition may indicate a first threshold value and a first target cell (e.g., A3 offset=0 dB and candite target cell=cell 1), a second configuration or condition may indicate a second threshold value and a second target cell (e.g., A5 offset=0 dB and candite target cell=cell 2), a third configuration or condition may indicate a third threshold value and a third target cell (e.g., A3 offset=0 dB and candite target cell=cell 3), and so on. To indicate these additional configurations or conditions, the NES mode indications may include multiple bits corresponding to a bitmap. For example, to indicate the three additional configurations or conditions for the first cell, the indication c₁ in the block 230-a may include four bits (e.g., one bit to indicate the NES mode of the first cell and three bits activating or deactivating the configurations or conditions).

FIGS. 3A and 3B show examples of control message configurations 301 and 302, respectively, that support CHO execution condition indication in accordance with one or more aspects of the present disclosure. The control message configurations 301 and 302 may implement, or be implemented by, one or more aspects of the wireless communications systems 100 and 200. For example, the control message configurations 301 and 302 may be examples of information blocks 305 included in a group common DCI message, such as the information blocks 230 in the DCI message 225 described with reference to FIG. 2. In some cases, the control message configurations 301 and 302 may be examples of control messages that are carried via a PDCCH. Such control messages may be communicated to a UE 115-c and a UE 115-d (which may be examples of the UE 115-a and the UE 115-b described with reference to FIG. 2) by a network entity 105 to indicate an NES mode status of one or more serving cells as described with reference to FIGS. 1 and 2.

The DCI messages illustrated by the control message configurations 301 and 302 may include a first information block 305-a indicating a DTX/DRX configuration for a first cell (e.g., bits a₁ and b₁ indicating DTX/DRX information for cell ID A), a second information block 305-b indicating a DTX/DRX configuration for a second cell (e.g., bits aₖ and bₖ indicating DTX/DRX information for cell ID B), and a third information block 305-c indicating a DTX/DRX configuration for a third cell (e.g., bits aₙ and bₙ indicating DTX/DRX information for cell ID C). In some cases, the first cell may be configured as a primary cell 310 for the UE 115-a and the second cell may be configured as a primary cell 310 for the UE 115-b. Additionally, the second cell may be configured as a secondary cell 315 for the UE 115-a and the first cell and the third cell may be configured as secondary cells 315 for the UE 115-b. In some cases, the UE 115-a and the UE 115-b may identify NES mode indications for the serving cells (e.g., c₁, cₖ, or the like described with reference to FIG. 2) in another information block 305-d, which may be an information block 305 that does not include the DTX/DRX configuration for a corresponding cell. In some cases, the network entity may indicate a position of the NES mode indication for a serving cell according to a parameter (e.g., positionInDCI-nesMode).

Referring to FIG. 3A, the control message configuration 301 shows an example of the group common DCI message including NES mode indications for one or more serving cells in an additional information block 305-d. An information block may include a sequence of NES mode indications, and each indication is associated with a serving cell, a primary cell or a secondary cell. Each indication may be a single bit indicating NES mode or non-NES mode. Alternatively, there may be plural bits indicating one of several NES modes for the respective cells. For example, the information block 305-d may be included at an end of the information blocks 305 (e.g., block N+1), and may include the NES mode indications in a sequence. The UEs 115 may identify the NES mode indications for a respective primary cell 310 and secondary cells 315 in the information block 305-d.

For example, the UE 115-a may identify the NES mode of the first cell (e.g., the primary cell 310) according to a value of c₁ in the information block 305-d and may identify the NES mode of the second cell (e.g., the secondary cell 315) according to a value of cx in the information block 305-d. Similarly, the UE 115-b may identify the NES mode of the second cell (e.g., the primary cell 310) according to a value of cₖ in the information block 305-d and may identify the NES mode of the first cell and the third cell (e.g., the secondary cells 315) according to a value of c₁ and cₙ in the information block 305-d.

Now referring to FIG. 3B, the control message configuration 302 shows an example of the group common DCI message including an NES mode indication for a serving cell in an information block 305-d that corresponds to a different serving cell. For example, the UE 115-a may identify the NES mode indication for the first cell (e.g., cell ID A associated with block 305-a) in the information block 305-d, which may indicate a DTX/DRX configuration for a fourth serving cell not associated with the UE 115-a (e.g., cell ID D not configured as a primary cell 310 or a secondary cell 315). In some cases, the NES mode indication for the first cell may be included with the DTX/DRX configuration bits for the fourth serving cell (e.g., information block 305-d may include bits a₂, b₂, and c₁). In some cases, other NES mode indications (e.g., cₖ corresponding to cell ID B) may be included in other information blocks 305, or may be included in a corresponding information block 305 (e.g., the information block 305-b).

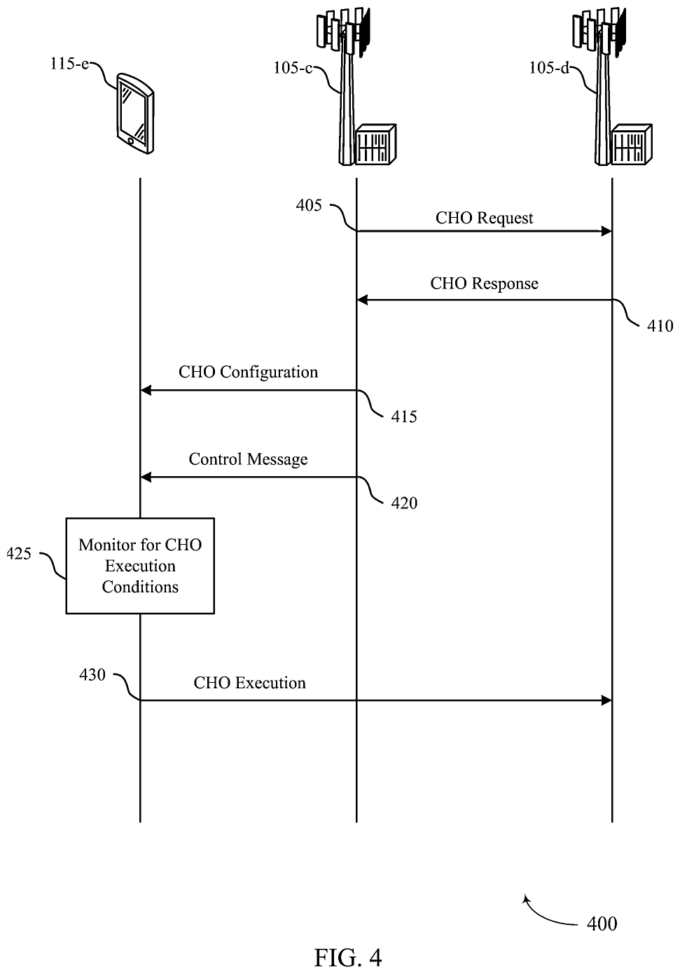

FIG. 4 shows an example of a process flow 400 that supports CHO execution condition indication in accordance with one or more aspects of the present disclosure. The process flow 400 may implement, or be implemented by, one or more aspects of the wireless communications systems 100 and 200, as well as the control message configurations 301 and 302. For example, the process flow 400 may show signaling between a UE 115-c, a network entity 105-c, and a network entity 105-d, which may be examples of corresponding devices described with reference to FIGS. 1 and 2. In some cases, the network entity 105-c may indicate, to the UE 115-c, an NES mode status of one or more serving cells using a group common control message, as described with reference to FIGS. 1 through 3B. Alternative examples of the following may be implemented, where some processes are performed in a different order than described or are not performed. In some cases, processes may include additional features not mentioned below, or further processes may be added.

At 405, the network entity 105-c (e.g., a first network entity) may communicate with the network entity 105-d (e.g., a second network entity) to establish a CHO configuration for at least the UE 115-c (e.g., a first UE). For example, the network entity 105-c may transmit a CHO request to the network entity 105-d, which may indicate a request for one or more neighbor cells of the network entity 105-d (e.g., one or more candidate cells belonging to the network entity 105-d) to act as target cells for the UE 115-c.

At 410, the network entity 105-d may respond to the CHO request with a CHO response, which may indicate acceptance of the CHO request (e.g., CHO request ACK) and a CHO configuration for the target cells (e.g., via a RRCReconfiguration*message). In some cases, the CHO configuration for the target cells may indicate one or more CHO execution conditions associated with the target cells.

At 415, the network entity 105-c may transmit a CHO configuration (which may be referred to as a second control message) to at least the UE 115-c. The CHO configuration may indicate one or more CHO execution conditions (e.g., events) for the UE 115-c to monitor for and the CHO configuration for the target cells (e.g., the RRCReconfiguration*). In some cases, the CHO configuration may indicate a bit position of an NES mode indication (which may be referred to as a second indication) within an upcoming control message via a parameter (e.g., positionInDCI-nesMode).

At 420, the network entity 105-c may transmit a common control message (e.g., a first control message) to a group of multiple UEs 115 including at least the UE 115-c. In some cases, the common control message may be a group common DCI message (e.g., having DCI format 2_9) that includes multiple information blocks corresponding to multiple cells. In some cases, one or more information blocks of the multiple information blocks may include one or more first indications providing a DTX configuration, a DRX configuration, or both (e.g., via a set of one or more bits) for one or more cells of the multiple cells. In some examples, at least a first information block of the multiple information blocks may include a second indication indicating an NES mode of a first cell of the multiple cells, where the first cell may be a primary cell for the UE 115-c. For example, the second indication may include a bit, where a first value of the bit (e.g., binary value ‘1’) indicates that the first cell enters the NES mode and a second value of the bit (e.g., binary value ‘0’) indicates that the first cell enters the non-NES mode. In some cases, the second indication may include multiple bits (e.g., corresponding to a bitmap), where a first bit of the multiple bits indicates the NES mode of the first cell and one or more second bits of the multiple bits activate one or more respective CHO configurations for the UE 115-c.

In a first example, the UE 115-e may receive, via the first information block, a first indication of the DTX configuration, the DRX configuration, or both for the first cell, where the first information block includes the second indication (e.g., the first information block includes both the DTX/DRX configuration and the NES mode indication for the first cell). In such examples, the second indication may be located in a second bit position that is after a first bit position corresponding to the first indication within the first information block. Alternatively, the second indication may be located in a second bit position that is before a first bit position corresponding to the first indication within the first information block.

In a second example, the UE 115-c may identify the NES mode indication for the first cell in another information block. For example, the UE 115-e may receive a second control message (e.g., the CHO configuration or another control message) indicating a bit position of the second indication within the common control message, where the bit position indicates that the second indication is included in a second information block of the multiple information blocks. In some cases, the second information block may include multiple third indications providing a respective NES mode associated with the multiple cells, which may include at least the second indication indicating the NES mode of a first cell. Alternatively, the second information block may include both of the second indication and a first indication of the DTX configuration, the DRX configuration, or both for a second cell of the multiple cells.

In some cases, the UE 115-e may identify an NES mode of one or more candidate target cells (e.g., secondary serving cells) in the common control message. For example, the UE 115-e may receive, via a second information block of the multiple information blocks, a third indication indicating an NES mode of a second cell of the multiple cells, where the second cell may be a candidate target cell for the UE 115-c and a primary cell for another UE of the group of UEs. In some examples, if the third indication indicates that the second cell is operating in the NES mode, the UE 115-c may remove the second cell from a list of candidate target cells for the CHO procedure.

At 425, the UE 115-e may monitor for one or more CHO execution conditions according to the CHO configuration and the NES mode of the primary cell. For example, the UE 115-e may monitor for a first CHO execution condition on the second indication indicating that the first cell operates in the NES mode (e.g., the first CHO execution condition associated with the NES mode). In some cases, the UE 115-c may transition, at a first time, between monitoring for the first CHO execution condition and a second CHO execution condition based on the second indication indicating that the first cell has transitioned between the NES mode and the non-NES mode, where the first time follows reception of the control message by a value corresponding to a duration, and where the duration is identified according to a subcarrier spacing associated with the PDCCH carrying the control message. For example, after transitioning, the UE 115-e may monitor for the first CHO execution condition based on the second indication indicating that the first cell has transitioned from the non-NES mode to the NES mode (e.g., the first CHO execution condition associated with the NES mode). Alternatively, the UE 115-a may identify that the second indication indicates that the first cell has transitioned from the NES mode to the non-NES mode, and may monitor for the second CHO execution condition according to the second indication.

At 430, the UE 115-e may perform the CHO procedure based on monitoring for the CHO execution condition. For example, the UE 115-e may establish a connection with the network entity 105-d (e.g., a target candidate cell, the second cell) based on the second indication indicating that the first cell is operating in the NES mode and the third indication indicating that the second cell is operating in a non-NES mode. In some cases, the UE 115-e may release a connection with the network entity 105-c (e.g., the primary cell, the first cell) based on establishing the connection with the network entity 105-d.

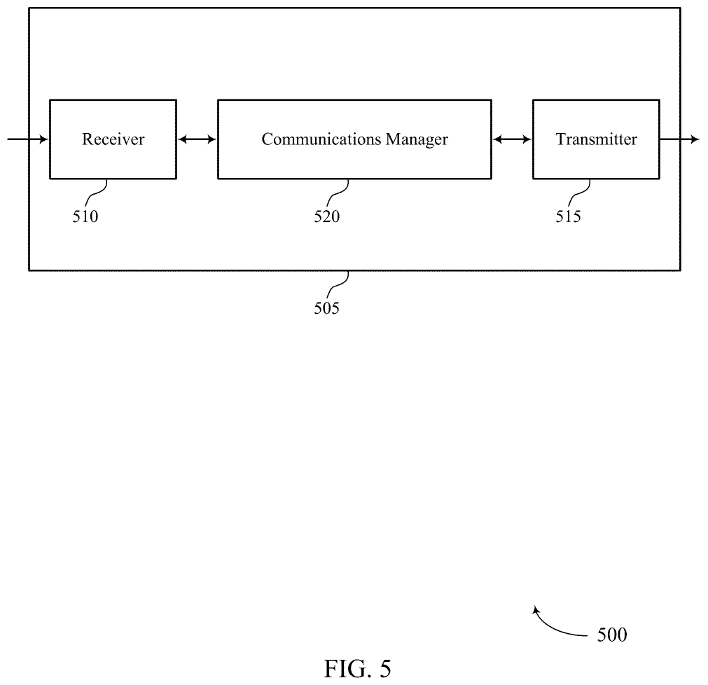

FIG. 5 shows a block diagram 500 of a device 505 that supports CHO execution condition indication in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, and the communications manager 520), may include at least one processor, which may be coupled with at least one memory, to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to CHO execution condition indication). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to CHO execution condition indication). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of CHO execution condition indication as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor. If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for receiving a control message common to a set of multiple UEs including at least the first UE, the control message including a set of multiple information blocks corresponding to a set of multiple cells, where: one or more information blocks of the set of multiple information blocks include one or more first indications providing a DTX configuration, a DRX configuration, or both for one or more cells of the set of multiple cells; and at least a first information block of the set of multiple information blocks includes a second indication indicating an NES mode of a first cell of the set of multiple cells, the first cell including a primary cell for the first UE. The communications manager 520 is capable of, configured to, or operable to support a means for monitoring a wireless channel for a CHO execution condition based on the NES mode of the primary cell. The communications manager 520 is capable of, configured to, or operable to support a means for performing a CHO procedure based on monitoring for the CHO execution condition.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for indicating an NES mode status of serving cells to a UE via a group common control message, which may improve CHO procedures in a wireless network.

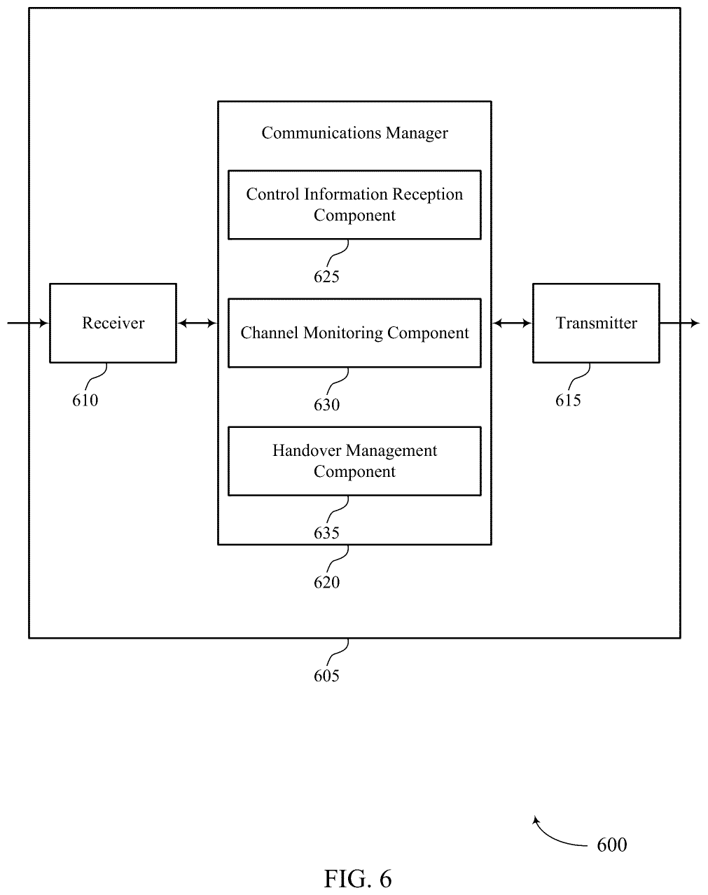

FIG. 6 shows a block diagram 600 of a device 605 that supports CHO execution condition indication in accordance with one or more aspects of the present disclosure. The device 605 may be an example of aspects of a device 505 or a UE 115 as described herein. The device 605 may include a receiver 610, a transmitter 615, and a communications manager 620. The device 605, or one or more components of the device 605 (e.g., the receiver 610, the transmitter 615, and the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, and information channels related to CHO execution condition indication). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to CHO execution condition indication). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of CHO execution condition indication as described herein. For example, the communications manager 620 may include a control information reception component 625, a channel monitoring component 630, a handover management component 635, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The control information reception component 625 is capable of, configured to, or operable to support a means for receiving a control message common to a set of multiple UEs including at least the first UE, the control message including a set of multiple information blocks corresponding to a set of multiple cells, where: one or more information blocks of the set of multiple information blocks include one or more first indications providing a DTX configuration, a DRX configuration, or both for one or more cells of the set of multiple cells; and at least a first information block of the set of multiple information blocks includes a second indication indicating an NES mode of a first cell of the set of multiple cells, the first cell including a primary cell for the first UE. The channel monitoring component 630 is capable of, configured to, or operable to support a means for monitoring a wireless channel for a CHO execution condition based on the NES mode of the primary cell. The handover management component 635 is capable of, configured to, or operable to support a means for performing a CHO procedure based on monitoring for the CHO execution condition.

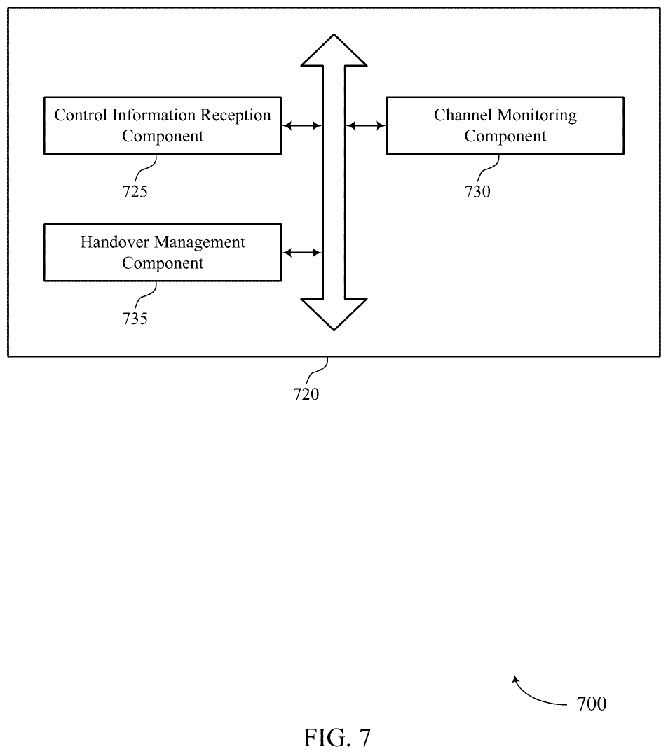

FIG. 7 shows a block diagram 700 of a communications manager 720 that supports CHO execution condition indication in accordance with one or more aspects of the present disclosure. The communications manager 720 may be an example of aspects of a communications manager 520, a communications manager 620, or both, as described herein. The communications manager 720, or various components thereof, may be an example of means for performing various aspects of CHO execution condition indication as described herein. For example, the communications manager 720 may include a control information reception component 725, a channel monitoring component 730, a handover management component 735, or any combination thereof. Each of these components, or components or subcomponents thereof (e.g., one or more processors, one or more memories), may communicate, directly or indirectly, with one another (e.g., via one or more buses).

The communications manager 720 may support wireless communications in accordance with examples as disclosed herein. The control information reception component 725 is capable of, configured to, or operable to support a means for receiving a control message common to a set of multiple UEs including at least the first UE, the control message including a set of multiple information blocks corresponding to a set of multiple cells, where: one or more information blocks of the set of multiple information blocks include one or more first indications providing a DTX configuration, a DRX configuration, or both for one or more cells of the set of multiple cells; and at least a first information block of the set of multiple information blocks includes a second indication indicating an NES mode of a first cell of the set of multiple cells, the first cell including a primary cell for the first UE. The channel monitoring component 730 is capable of, configured to, or operable to support a means for monitoring a wireless channel for a CHO execution condition based on the NES mode of the primary cell. The handover management component 735 is capable of, configured to, or operable to support a means for performing a CHO procedure based on monitoring for the CHO execution condition.

In some examples, to support monitoring the wireless channel for the CHO execution condition, the channel monitoring component 730 is capable of, configured to, or operable to support a means for monitoring for a first CHO execution condition based on the second indication indicating that the first cell operates in the NES mode, the first CHO execution condition associated with the NES mode. In some examples, to support monitoring the wireless channel for the CHO execution condition, the channel monitoring component 730 is capable of, configured to, or operable to support a means for monitoring for a second CHO execution condition based on the second indication indicating that the first cell operates in a non-NES mode, the second CHO execution condition associated with the non-NES mode.

In some examples, the control information reception component 725 is capable of, configured to, or operable to support a means for receiving, via the first information block, a first indication of the DTX configuration, the DRX configuration, or both for the first cell, where the first information block includes the second indication.

In some examples, the second indication is located in a second bit position that is after a first bit position corresponding to the first indication within the first information block.

In some examples, the second indication is located in a second bit position that is before a first bit position corresponding to the first indication within the first information block.

In some examples, the control information reception component 725 is capable of, configured to, or operable to support a means for receiving a second control message including a bit position of the second indication within the control message, where the bit position indicates that the second indication is included in a second information block of the set of multiple information blocks.

In some examples, the second information block includes both of the second indication and a first indication of the DTX configuration, the DRX configuration, or both for a second cell of the set of multiple cells.

In some examples, the second information block includes a set of multiple third indications providing a respective NES mode associated with the set of multiple cells, the set of multiple third indications including at least the second indication indicating the NES mode of a first cell.

In some examples, the control information reception component 725 is capable of, configured to, or operable to support a means for receiving, via a second information block of the one or more information blocks, a third indication indicating an NES mode of a second cell of the set of multiple cells, where the second cell is a candidate target cell for the first UE and a primary cell for a second UE of the set of multiple UEs.

In some examples, to support performing the CHO procedure, the handover management component 735 is capable of, configured to, or operable to support a means for establishing a connection with the second cell based on the second indication indicating that the first cell is operating in the NES mode and the third indication indicating that the second cell is operating in a non-NES mode.

In some examples, the handover management component 735 is capable of, configured to, or operable to support a means for removing the second cell from a list of candidate target cells based on the third indication indicating that the second cell is operating in the NES mode.

In some examples, the second indication includes a set of multiple bits. In some examples, a first bit of the set of multiple bits indicates the NES mode of the first cell and one or more second bits of the set of multiple bits activate one or more respective CHO configurations for the first UE.

In some examples, the handover management component 735 is capable of, configured to, or operable to support a means for transitioning, at a first time, between monitoring for a first CHO execution condition and a second condition handover execution condition based on the second indication indicating that the first cell has transitioned between the NES mode and a non-NES mode, where the first time follows reception of the control message by a value corresponding to a duration.

In some examples, the duration is identified according to a subcarrier spacing associated with the control message.

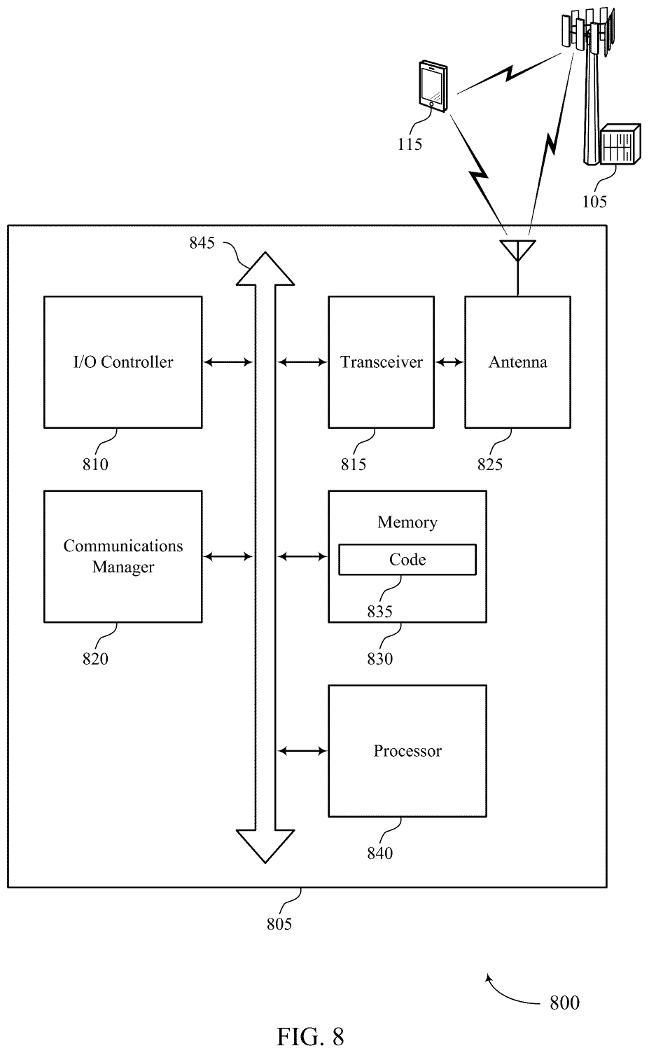

FIG. 8 shows a diagram of a system 800 including a device 805 that supports CHO execution condition indication in accordance with one or more aspects of the present disclosure. The device 805 may be an example of or include the components of a device 505, a device 605, or a UE 115 as described herein. The device 805 may communicate (e.g., wirelessly) with one or more network entities 105, one or more UEs 115, or any combination thereof. The device 805 may include components for bi-directional voice and data communications including components for transmitting and receiving communications, such as a communications manager 820, an input/output (I/O) controller 810, a transceiver 815, an antenna 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable code 835 including instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may contain, among other things, a basic I/O system (BIOS) which may control basic hardware or software operation such as the interaction with peripheral components or devices.

The at least one processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting CHO execution condition indication). For example, the device 805 or a component of the device 805 may include at least one processor 840 and at least one memory 830 coupled with or to the at least one processor 840, the at least one processor 840 and at least one memory 830 configured to perform various functions described herein. In some examples, the at least one processor 840 may include multiple processors and the at least one memory 830 may include multiple memories. One or more of the multiple processors may be coupled with one or more of the multiple memories, which may, individually or collectively, be configured to perform various functions herein. In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. As such, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code stored in the at least one memory 830 or otherwise, to perform one or more of the functions described herein.

The communications manager 820 may support wireless communications in accordance with examples as disclosed herein. For example, the communications manager 820 is capable of, configured to, or operable to support a means for receiving a control message common to a set of multiple UEs including at least the first UE, the control message including a set of multiple information blocks corresponding to a set of multiple cells, where: one or more information blocks of the set of multiple information blocks include one or more first indications providing a DTX configuration, a DRX configuration, or both for one or more cells of the set of multiple cells; and at least a first information block of the set of multiple information blocks includes a second indication indicating an NES mode of a first cell of the set of multiple cells, the first cell including a primary cell for the first UE. The communications manager 820 is capable of, configured to, or operable to support a means for monitoring a wireless channel for a CHO execution condition based on the NES mode of the primary cell. The communications manager 820 is capable of, configured to, or operable to support a means for performing a CHO procedure based on monitoring for the CHO execution condition.

By including or configuring the communications manager 820 in accordance with examples as described herein, the device 805 may support techniques for indicating an NES mode status of serving cells to a UE via a group common control message, which may improve CHO procedures in a wireless network by improving dynamic transition between power savings modes.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of CHO execution condition indication as described herein, or the at least one processor 840 and the at least one memory 830 may be otherwise configured to, individually or collectively, perform or support such operations.

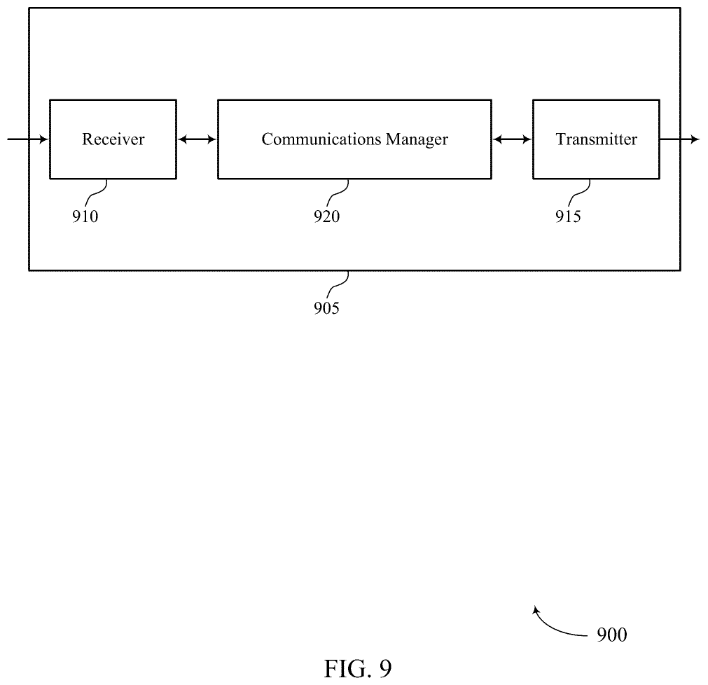

FIG. 9 shows a block diagram 900 of a device 905 that supports CHO execution condition indication in accordance with one or more aspects of the present disclosure. The device 905 may be an example of aspects of a network entity 105 as described herein. The device 905 may include a receiver 910, a transmitter 915, and a communications manager 920. The device 905, or one or more components of the device 905 (e.g., the receiver 910, the transmitter 915, and the communications manager 920), may include at least one processor, which may be coupled with at least one memory, to, individually or collectively, support or enable the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations thereof or various components thereof may be examples of means for performing various aspects of CHO execution condition indication as described herein. For example, the communications manager 920, the receiver 910, the transmitter 915, or various combinations or components thereof may be capable of performing one or more of the functions described herein.

In some examples, the communications manager 920, the receiver 910, the transmitter 915, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 920, the receiver 910, the transmitter 915, or various combinations or components thereof may be implemented in code (e.g., as communications management software or firmware) executed by at least one processor. If implemented in code executed by at least one processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. For example, the communications manager 920 is capable of, configured to, or operable to support a means for communicating with a second network entity to establish a CHO configuration for at least a first UE. The communications manager 920 is capable of, configured to, or operable to support a means for transmitting, to a set of multiple UEs including at least the first UE, a common control message including a set of multiple information blocks corresponding to a set of multiple cells, where: one or more information blocks of the set of multiple information blocks include one or more first indications providing a DTX configuration, a DRX configuration, or both for one or more cells of the set of multiple cells; and at least a first information block of the set of multiple information blocks includes a second indication indicating an NES mode of a first cell of the set of multiple cells, the first cell including a primary cell for the first UE.

By including or configuring the communications manager 920 in accordance with examples as described herein, the device 905 (e.g., at least one processor controlling or otherwise coupled with the receiver 910, the transmitter 915, the communications manager 920, or a combination thereof) may support techniques for indicating an NES mode status of serving cells to a UE via a group common control message, which may improve CHO procedures in a wireless network by improving dynamic transition between power savings modes.

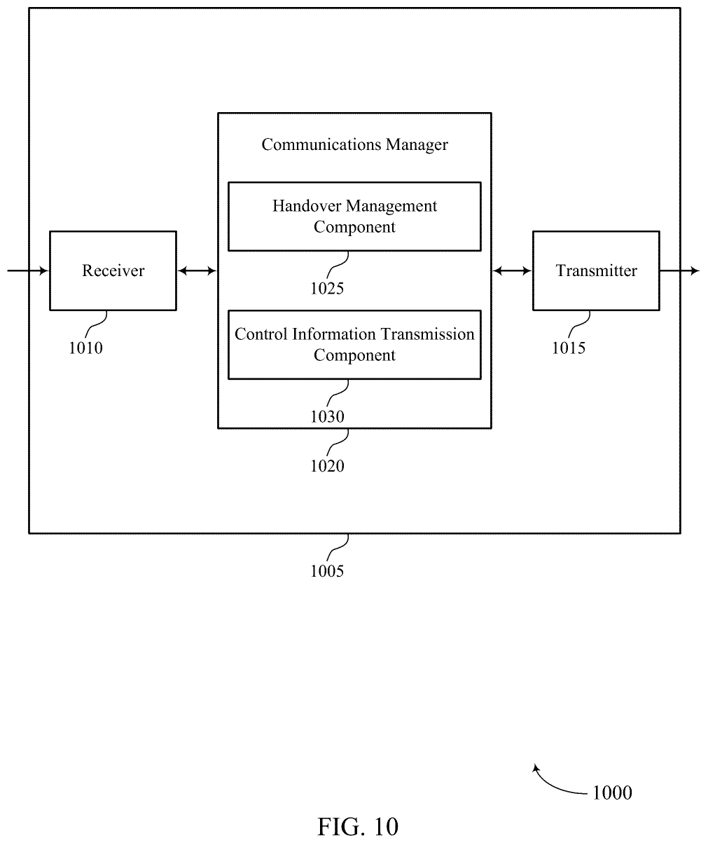

FIG. 10 shows a block diagram 1000 of a device 1005 that supports CHO execution condition indication in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005, or one or more components of the device 1005 (e.g., the receiver 1010, the transmitter 1015, and the communications manager 1020), may include at least one processor, which may be coupled with at least one memory, to support the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of CHO execution condition indication as described herein. For example, the communications manager 1020 may include a handover management component 1025 a control information transmission component 1030, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. The handover management component 1025 is capable of, configured to, or operable to support a means for communicating with a second network entity to establish a CHO configuration for at least a first UE. The control information transmission component 1030 is capable of, configured to, or operable to support a means for transmitting, to a set of multiple UEs including at least the first UE, a common control message including a set of multiple information blocks corresponding to a set of multiple cells, where: one or more information blocks of the set of multiple information blocks include one or more first indications providing a DTX configuration, a DRX configuration, or both for one or more cells of the set of multiple cells; and at least a first information block of the set of multiple information blocks includes a second indication indicating an NES mode of a first cell of the set of multiple cells, the first cell including a primary cell for the first UE.

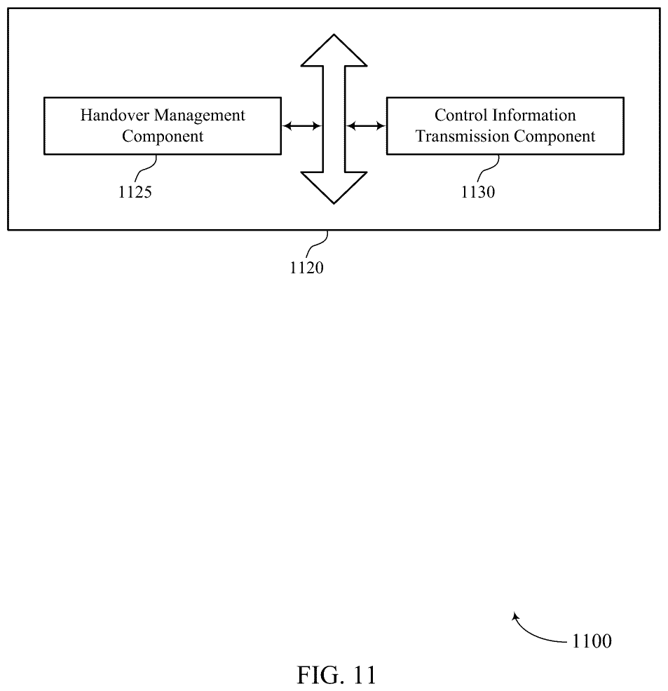

FIG. 11 shows a block diagram 1100 of a communications manager 1120 that supports CHO execution condition indication in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of CHO execution condition indication as described herein. For example, the communications manager 1120 may include a handover management component 1125 a control information transmission component 1130, or any combination thereof. Each of these components, or components or subcomponents thereof (e.g., one or more processors, one or more memories), may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communications in accordance with examples as disclosed herein. The handover management component 1125 is capable of, configured to, or operable to support a means for communicating with a second network entity to establish a CHO configuration for at least a first UE. The control information transmission component 1130 is capable of, configured to, or operable to support a means for transmitting, to a set of multiple UEs including at least the first UE, a common control message including a set of multiple information blocks corresponding to a set of multiple cells, where: one or more information blocks of the set of multiple information blocks include one or more first indications providing a DTX configuration, a DRX configuration, or both for one or more cells of the set of multiple cells; and at least a first information block of the set of multiple information blocks includes a second indication indicating an NES mode of a first cell of the set of multiple cells, the first cell including a primary cell for the first UE.

In some examples, the control information transmission component 1130 is capable of, configured to, or operable to support a means for transmitting, via the first information block, a first indication of the DTX configuration, the DRX configuration, or both for the first cell, where the first information block includes the second indication.

In some examples, the second indication is located in a second bit position that is after a first bit position corresponding to the first indication within the first information block.

In some examples, the second indication is located in a second bit position that is before a first bit position corresponding to the first indication within the first information block.

In some examples, the control information transmission component 1130 is capable of, configured to, or operable to support a means for transmitting a second control message including a bit position of the second indication within the control message, where the bit position indicates that the second indication is included in a second information block of the set of multiple information blocks.

In some examples, the second information block includes both of the second indication and a first indication of the DTX configuration, the DRX configuration, or both for a second cell of the set of multiple cells.

In some examples, the second information block includes a set of multiple third indications providing a respective NES mode associated with the set of multiple cells, the set of multiple third indications including at least the second indication indicating the NES mode of a first cell.

In some examples, the control information transmission component 1130 is capable of, configured to, or operable to support a means for transmitting, via a second information block of the one or more information blocks, a third indication indicating an NES mode of a second cell of the set of multiple cells, where the second cell is a candidate target cell for the first UE and a primary cell for a second UE of the set of multiple UEs.

In some examples, the second indication includes a set of multiple bits. In some examples, a first bit of the set of multiple bits indicates the NES mode of the first cell and one or more second bits of the set of multiple bits activate one or more respective CHO configurations for the first UE.

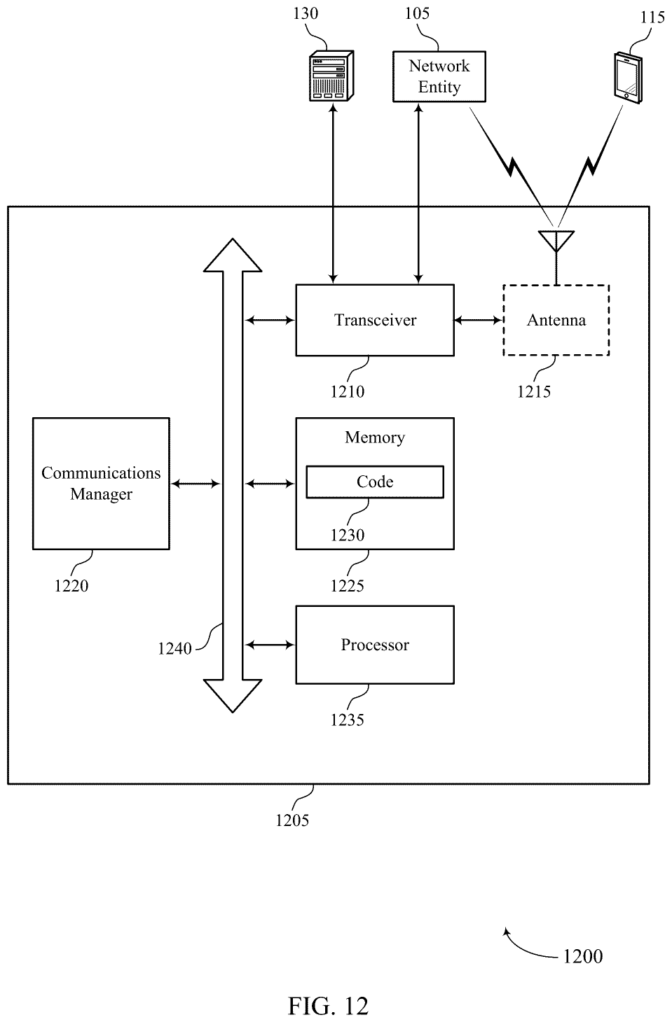

FIG. 12 shows a diagram of a system 1200 including a device 1205 that supports CHO execution condition indication in accordance with one or more aspects of the present disclosure. The device 1205 may be an example of or include the components of a device 905, a device 1005, or a network entity 105 as described herein. The device 1205 may communicate with one or more network entities 105, one or more UEs 115, or any combination thereof, which may include communications over one or more wired interfaces, over one or more wireless interfaces, or any combination thereof. The device 1205 may include components that support outputting and obtaining communications, such as a communications manager 1220, a transceiver 1210, an antenna 1215, at least one memory 1225, code 1230, and at least one processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or one or more memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or one or more memory components (e.g., the at least one processor 1235, the at least one memory 1225, or both), may be included in a chip or chip assembly that is installed in the device 1205. In some examples, the transceiver 1210 may be operable to support communications via one or more communications links (e.g., a communication link 125, a backhaul communication link 120, a midhaul communication link 162, a fronthaul communication link 168).

The at least one memory 1225 may include RAM, ROM, or any combination thereof. The at least one memory 1225 may store computer-readable, computer-executable code 1230 including instructions that, when executed by one or more of the at least one processor 1235, cause the device 1205 to perform various functions described herein. The code 1230 may be stored in a non-transitory computer-readable medium such as system memory or another type of memory. In some cases, the code 1230 may not be directly executable by a processor of the at least one processor 1235 but may cause a computer (e.g., when compiled and executed) to perform functions described herein. In some cases, the at least one memory 1225 may contain, among other things, a BIOS which may control basic hardware or software operation such as the interaction with peripheral components or devices. In some examples, the at least one processor 1235 may include multiple processors and the at least one memory 1225 may include multiple memories. One or more of the multiple processors may be coupled with one or more of the multiple memories which may, individually or collectively, be configured to perform various functions herein (for example, as part of a processing system).

The at least one processor 1235 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the at least one processor 1235 may be configured to operate a memory array using a memory controller. In some other cases, a memory controller may be integrated into one or more of the at least one processor 1235. The at least one processor 1235 may be configured to execute computer-readable instructions stored in a memory (e.g., one or more of the at least one memory 1225) to cause the device 1205 to perform various functions (e.g., functions or tasks supporting CHO execution condition indication). For example, the device 1205 or a component of the device 1205 may include at least one processor 1235 and at least one memory 1225 coupled with one or more of the at least one processor 1235, the at least one processor 1235 and the at least one memory 1225 configured to perform various functions described herein. The at least one processor 1235 may be an example of a cloud-computing platform (e.g., one or more physical nodes and supporting software such as operating systems, virtual machines, or container instances) that may host the functions (e.g., by executing code 1230) to perform the functions of the device 1205. The at least one processor 1235 may be any one or more suitable processors capable of executing scripts or instructions of one or more software programs stored in the device 1205 (such as within one or more of the at least one memory 1225). In some examples, the at least one processor 1235 may include multiple processors and the at least one memory 1225 may include multiple memories. One or more of the multiple processors may be coupled with one or more of the multiple memories, which may, individually or collectively, be configured to perform various functions herein. In some examples, the at least one processor 1235 may be a component of a processing system, which may refer to a system (such as a series) of machines, circuitry (including, for example, one or both of processor circuitry (which may include the at least one processor 1235) and memory circuitry (which may include the at least one memory 1225)), or components, that receives or obtains inputs and processes the inputs to produce, generate, or obtain a set of outputs. The processing system may be configured to perform one or more of the functions described herein. As such, the at least one processor 1235 or a processing system including the at least one processor 1235 may be configured to, configurable to, or operable to cause the device 1205 to perform one or more of the functions described herein. Further, as described herein, being “configured to,” being “configurable to,” and being “operable to” may be used interchangeably and may be associated with a capability, when executing code stored in the at least one memory 1225 or otherwise, to perform one or more of the functions described herein.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the at least one memory 1225, the code 1230, and the at least one processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with other network entities 105, and may include a controller or scheduler for controlling communications with UEs 115 in cooperation with other network entities 105. In some examples, the communications manager 1220 may support an X2 interface within an LTE/LTE-A wireless communications network technology to provide communication between network entities 105.

The communications manager 1220 may support wireless communications in accordance with examples as disclosed herein. For example, the communications manager 1220 is capable of, configured to, or operable to support a means for communicating with a second network entity to establish a CHO configuration for at least a first UE. The communications manager 1220 is capable of, configured to, or operable to support a means for transmitting, to a set of multiple UEs including at least the first UE, a common control message including a set of multiple information blocks corresponding to a set of multiple cells, where: one or more information blocks of the set of multiple information blocks include one or more first indications providing a DTX configuration, a DRX configuration, or both for one or more cells of the set of multiple cells; and at least a first information block of the set of multiple information blocks includes a second indication indicating an NES mode of a first cell of the set of multiple cells, the first cell including a primary cell for the first UE.

By including or configuring the communications manager 1220 in accordance with examples as described herein, the device 1205 may support techniques for indicating an NES mode status of serving cells to a UE via a group common control message, which may improve CHO procedures in a wireless network by improving dynamic transition between power savings modes.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the transceiver 1210, one or more of the at least one processor 1235, one or more of the at least one memory 1225, the code 1230, or any combination thereof (for example, by a processing system including at least a portion of the at least one processor 1235, the at least one memory 1225, the code 1230, or any combination thereof). For example, the code 1230 may include instructions executable by one or more of the at least one processor 1235 to cause the device 1205 to perform various aspects of CHO execution condition indication as described herein, or the at least one processor 1235 and the at least one memory 1225 may be otherwise configured to, individually or collectively, perform or support such operations.

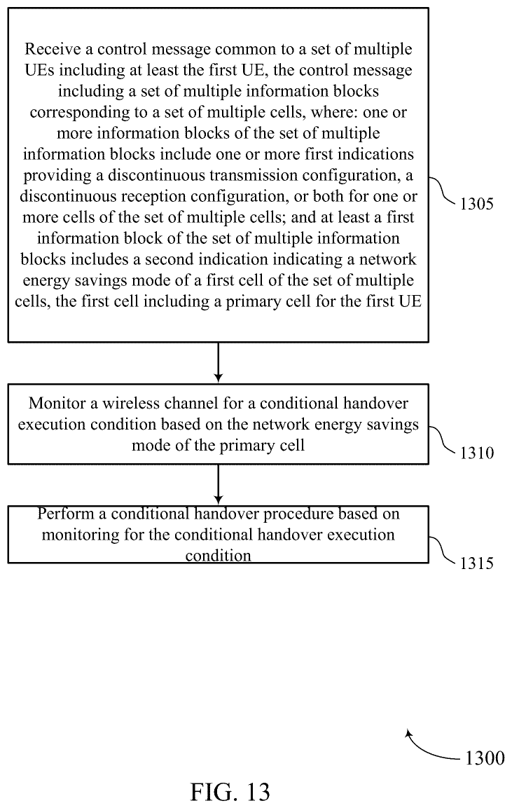

FIG. 13 shows a flowchart illustrating a method 1300 that supports CHO execution condition indication in accordance with aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include receiving a control message common to a set of multiple UEs including at least the first UE, the control message including a set of multiple information blocks corresponding to a set of multiple cells, where: one or more information blocks of the set of multiple information blocks include one or more first indications providing a DTX configuration, a DRX configuration, or both for one or more cells of the set of multiple cells; and at least a first information block of the set of multiple information blocks includes a second indication indicating an NES mode of a first cell of the set of multiple cells, the first cell including a primary cell for the first UE. The operations of block 1305 may be performed in accordance with examples as disclosed herein. In some examples, aspects of the operations of 1305 may be performed by a control information reception component 725 as described with reference to FIG. 7.

At 1310, the method may include monitoring a wireless channel for a CHO execution condition based on the NES mode of the primary cell. The operations of block 1310 may be performed in accordance with examples as disclosed herein. In some examples, aspects of the operations of 1310 may be performed by a channel monitoring component 730 as described with reference to FIG. 7.

At 1315, the method may include performing a CHO procedure based on monitoring for the CHO execution condition. The operations of block 1315 may be performed in accordance with examples as disclosed herein. In some examples, aspects of the operations of 1315 may be performed by a handover management component 735 as described with reference to FIG. 7.

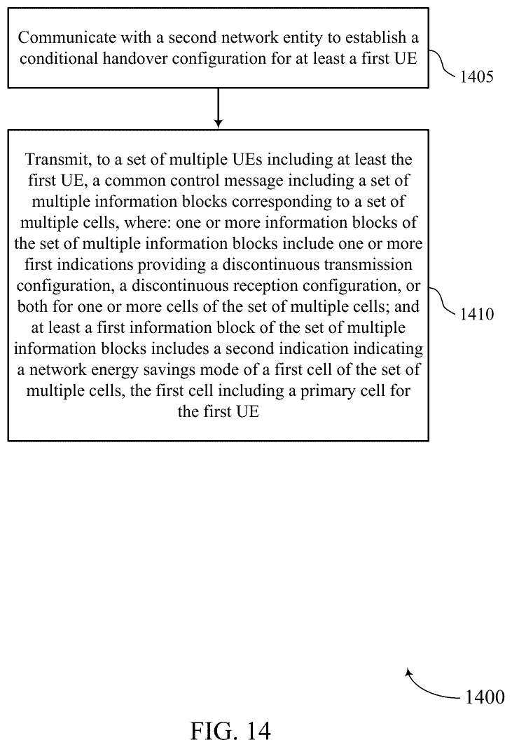

FIG. 14 shows a flowchart illustrating a method 1400 that supports CHO execution condition indication in accordance with aspects of the present disclosure. The operations of the method 1400 may be implemented by a network entity or its components as described herein. For example, the operations of the method 1400 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1405, the method may include communicating with a second network entity to establish a CHO configuration for at least a first UE. The operations of block 1405 may be performed in accordance with examples as disclosed herein. In some examples, aspects of the operations of 1405 may be performed by a handover management component 1125 as described with reference to FIG. 11.

At 1410, the method may include transmitting, to a set of multiple UEs including at least the first UE, a common control message including a set of multiple information blocks corresponding to a set of multiple cells, where: one or more information blocks of the set of multiple information blocks include one or more first indications providing a DTX configuration, a DRX configuration, or both for one or more cells of the set of multiple cells; and at least a first information block of the set of multiple information blocks includes a second indication indicating an NES mode of a first cell of the set of multiple cells, the first cell including a primary cell for the first UE. The operations of block 1410 may be performed in accordance with examples as disclosed herein. In some examples, aspects of the operations of 1410 may be performed by a control information transmission component 1130 as described with reference to FIG. 11.

The following provides an overview of aspects of the present disclosure:
Aspect 1: A method for wireless communications by a first UE, comprising: receiving a control message common to a plurality of UEs comprising at least the first UE, the control message comprising a plurality of information blocks corresponding to a plurality of cells, wherein: one or more information blocks of the plurality of information blocks comprise one or more first indications providing a DTX configuration, a DRX configuration, or both for one or more cells of the plurality of cells; and at least a first information block of the plurality of information blocks comprises a second indication indicating an NES mode of a first cell of the plurality of cells, the first cell comprising a primary cell for the first UE; monitoring a wireless channel for a CHO execution condition based at least in part on the NES mode of the primary cell; and performing a CHO procedure based at least in part on monitoring for the CHO execution condition.
Aspect 2: The method of aspect 1, wherein monitoring the wireless channel for the CHO execution condition comprises: monitoring for a first CHO execution condition based at least in part on the second indication indicating that the first cell operates in the NES mode, the first CHO execution condition associated with the NES mode; or monitoring for a second CHO execution condition based at least in part on the second indication indicating that the first cell operates in a non-NES mode, the second CHO execution condition associated with the non-NES mode.
Aspect 3: The method of any of aspects 1 through 2, further comprising: receiving, via the first information block, a first indication of the DTX configuration, the DRX configuration, or both for the first cell, wherein the first information block comprises the second indication.
Aspect 4: The method of aspect 3, wherein the second indication is located in a second bit position that is after a first bit position corresponding to the first indication within the first information block.
Aspect 5: The method of aspect 3, wherein the second indication is located in a second bit position that is before a first bit position corresponding to the first indication within the first information block.
Aspect 6: The method of any of aspects 1 through 5, further comprising: receiving a second control message comprising a bit position of the second indication within the control message, wherein the bit position indicates that the second indication is included in a second information block of the plurality of information blocks.
Aspect 7: The method of aspect 6, wherein the second information block comprises both of the second indication and a first indication of the DTX configuration, the DRX configuration, or both for a second cell of the plurality of cells.
Aspect 8: The method of any of aspects 6 through 7, wherein the second information block comprises a plurality of third indications providing a respective NES mode associated with the plurality of cells, the plurality of third indications comprising at least the second indication indicating the NES mode of a first cell.
Aspect 9: The method of any of aspects 1 through 8, further comprising: receiving, via a second information block of the one or more information blocks, a third indication indicating an NES mode of a second cell of the plurality of cells, wherein the second cell is a candidate target cell for the first UE and a primary cell for a second UE of the plurality of UEs.
Aspect 10: The method of aspect 9, wherein performing the CHO procedure comprises: establishing a connection with the second cell based at least in part on the second indication indicating that the first cell is operating in the NES mode and the third indication indicating that the second cell is operating in a non-NES mode.
Aspect 11: The method of aspect 9, further comprising: removing the second cell from a list of candidate target cells based at least in part on the third indication indicating that the second cell is operating in the NES mode.
Aspect 12: The method of any of aspects 1 through 11, wherein the second indication comprises a plurality of bits, a first bit of the plurality of bits indicates the NES mode of the first cell and one or more second bits of the plurality of bits activate one or more respective CHO configurations for the first UE.
Aspect 13: The method of any of aspects 1 through 12, further comprising: transitioning, at a first time, between monitoring for a first CHO execution condition and a second condition handover execution condition based at least in part on the second indication indicating that the first cell has transitioned between the NES mode and a non-NES mode, wherein the first time follows reception of the control message by a value corresponding to a duration.
Aspect 14: The method of aspect 13, wherein the duration is identified according to a subcarrier spacing associated with the control message.
Aspect 15: A method for wireless communications at a first network entity, comprising: communicating with a second network entity to establish a CHO configuration for at least a first UE; and transmitting, to a plurality of UEs comprising at least the first UE, a common control message comprising a plurality of information blocks corresponding to a plurality of cells, wherein: one or more information blocks of the plurality of information blocks comprise one or more first indications providing a DTX configuration, a DRX configuration, or both for one or more cells of the plurality of cells; and at least a first information block of the plurality of information blocks comprises a second indication indicating an NES mode of a first cell of the plurality of cells, the first cell comprising a primary cell for the first UE.
Aspect 16: The method of aspect 15, further comprising: transmitting, via the first information block, a first indication of the DTX configuration, the DRX configuration, or both for the first cell, wherein the first information block comprises the second indication.
Aspect 17: The method of aspect 16, wherein the second indication is located in a second bit position that is after a first bit position corresponding to the first indication within the first information block.
Aspect 18: The method of aspect 16, wherein the second indication is located in a second bit position that is before a first bit position corresponding to the first indication within the first information block.
Aspect 19: The method of any of aspects 15 through 18, further comprising: transmitting a second control message comprising a bit position of the second indication within the control message, wherein the bit position indicates that the second indication is included in a second information block of the plurality of information blocks.
Aspect 20: The method of aspect 19, wherein the second information block comprises both of the second indication and a first indication of the DTX configuration, the DRX configuration, or both for a second cell of the plurality of cells.
Aspect 21: The method of any of aspects 19 through 20, wherein the second information block comprises a plurality of third indications providing a respective NES mode associated with the plurality of cells, the plurality of third indications comprising at least the second indication indicating the NES mode of a first cell.
Aspect 22: The method of any of aspects 15 through 21, further comprising: transmitting, via a second information block of the one or more information blocks, a third indication indicating an NES mode of a second cell of the plurality of cells, wherein the second cell is a candidate target cell for the first UE and a primary cell for a second UE of the plurality of UEs.
Aspect 23: The method of any of aspects 15 through 22, wherein the second indication comprises a plurality of bits, a first bit of the plurality of bits indicates the NES mode of the first cell and one or more second bits of the plurality of bits activate one or more respective CHO configurations for the first UE.
Aspect 24: A first UE for wireless communications, comprising one or more memories storing processor-executable code, and one or more processors coupled with the one or more memories and individually or collectively operable to execute the code to cause the first UE to perform a method of any of aspects 1 through 14.
Aspect 25: A first UE for wireless communications, comprising at least one means for performing a method of any of aspects 1 through 14.
Aspect 26: A non-transitory computer-readable medium storing code for wireless communications, the code comprising instructions executable by a processor to perform a method of any of aspects 1 through 14.
Aspect 27: A first network entity for wireless communications, comprising one or more memories storing processor-executable code, and one or more processors coupled with the one or more memories and individually or collectively operable to execute the code to cause the first network entity to perform a method of any of aspects 15 through 23.
Aspect 28: A first network entity for wireless communications, comprising at least one means for performing a method of any of aspects 15 through 23.
Aspect 29: A non-transitory computer-readable medium storing code for wireless communications, the code comprising instructions executable by a processor to perform a method of any of aspects 15 through 23.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A first user equipment (UE), comprising:
one or more memories storing processor-executable code; and
one or more processors coupled with the one or more memories and individually or collectively operable to execute the code to cause the first UE to:
receive a control message common to a plurality of UEs comprising at least the first UE, the control message comprising a plurality of information blocks corresponding to a plurality of cells, wherein:
one or more information blocks of the plurality of information blocks comprise one or more first indications providing a discontinuous transmission configuration, a discontinuous reception configuration, or both for one or more cells of the plurality of cells; and
at least a first information block of the plurality of information blocks comprises a second indication indicating a network energy savings mode of a first cell of the plurality of cells, the first cell comprising a primary cell for the first UE;
monitor a wireless channel for a conditional handover execution condition based at least in part on the network energy savings mode of the primary cell indicated by the second indication; and
perform a conditional handover procedure based at least in part on monitoring for the conditional handover execution condition.

2. The first UE of claim 1, wherein, to monitor the wireless channel for the conditional handover execution condition, the one or more processors are individually or collectively operable to execute the code to cause the first UE to:
monitor for a first conditional handover execution condition based at least in part on the second indication indicating that the first cell operates in the network energy savings mode, the first conditional handover execution condition associated with the network energy savings mode; or
monitor for a second conditional handover execution condition based at least in part on the second indication indicating that the first cell operates in a non-network energy savings mode, the second conditional handover execution condition associated with the non-network energy savings mode.

3. The first UE of claim 1, wherein the one or more processors are individually or collectively further operable to execute the code to cause the first UE to:
receive, via the first information block, a first indication of the discontinuous transmission configuration, the discontinuous reception configuration, or both for the first cell, wherein the first information block comprises the second indication.

4. The first UE of claim 3, wherein the second indication is located in a second bit position that is after a first bit position corresponding to the first indication within the first information block.

5. The first UE of claim 3, wherein the second indication is located in a second bit position that is before a first bit position corresponding to the first indication within the first information block.

6. The first UE of claim 1, wherein the one or more processors are individually or collectively further operable to execute the code to cause the first UE to:
receive a second control message comprising a bit position of the second indication within the control message, wherein the bit position indicates that the second indication is included in a second information block of the plurality of information blocks.

7. The first UE of claim 6, wherein the second information block comprises both of the second indication and a first indication of the discontinuous transmission configuration, the discontinuous reception configuration, or both for a second cell of the plurality of cells.

8. The first UE of claim 6, wherein the second information block comprises a plurality of third indications providing a respective network energy savings mode associated with the plurality of cells, the plurality of third indications comprising at least the second indication indicating the network energy savings mode of a first cell.

9. The first UE of claim 1, wherein the one or more processors are individually or collectively further operable to execute the code to cause the first UE to:
receive, via a second information block of the one or more information blocks, a third indication indicating a network energy savings mode of a second cell of the plurality of cells, wherein the second cell is a candidate target cell for the first UE and a primary cell for a second UE of the plurality of UEs.

10. The first UE of claim 9, wherein, to perform the conditional handover procedure, the one or more processors are individually or collectively operable to execute the code to cause the first UE to:
establish a connection with the second cell based at least in part on the second indication indicating that the first cell is operating in the network energy savings mode and the third indication indicating that the second cell is operating in a non-network energy savings mode.

11. The first UE of claim 9, wherein the one or more processors are individually or collectively further operable to execute the code to cause the first UE to:
remove the second cell from a list of candidate target cells based at least in part on the third indication indicating that the second cell is operating in the network energy savings mode.

12. The first UE of claim 1, wherein the second indication comprises a plurality of bits, and a first bit of the plurality of bits indicates the network energy savings mode of the first cell and one or more second bits of the plurality of bits activate one or more respective conditional handover configurations for the first UE.

13. The first UE of claim 1, wherein the one or more processors are individually or collectively further operable to execute the code to cause the first UE to:
transition, at a first time, between monitoring for a first conditional handover execution condition and a second condition handover execution condition based at least in part on the second indication indicating that the first cell has transitioned between the network energy savings mode and a non-network energy savings mode, wherein the first time follows reception of the control message by a value corresponding to a duration.

14. The first UE of claim 13, wherein the duration is identified according to a subcarrier spacing associated with the control message.

15. A first network entity, comprising:
one or more memories storing processor-executable code; and
one or more processors coupled with the one or more memories and individually or collectively operable to execute the code to cause the first network entity to:
communicate with a second network entity to establish a conditional handover configuration for at least a first user equipment (UE); and
transmit, to a plurality of UEs comprising at least the first UE, a common control message comprising a plurality of information blocks corresponding to a plurality of cells, wherein:
one or more information blocks of the plurality of information blocks comprise one or more first indications providing a discontinuous transmission configuration, a discontinuous reception configuration, or both for one or more cells of the plurality of cells; and
at least a first information block of the plurality of information blocks comprises a second indication indicating a network energy savings mode of a first cell of the plurality of cells, the first cell comprising a primary cell for the first UE.

16. The first network entity of claim 15, wherein the one or more processors are individually or collectively further operable to execute the code to cause the first network entity to:
transmit, via the first information block, a first indication of the discontinuous transmission configuration, the discontinuous reception configuration, or both for the first cell, wherein the first information block comprises the second indication.

17. The first network entity of claim 16, wherein the second indication is located in a second bit position that is after a first bit position corresponding to the first indication within the first information block.

18. The first network entity of claim 16, wherein the second indication is located in a second bit position that is before a first bit position corresponding to the first indication within the first information block.

19. The first network entity of claim 15, wherein the one or more processors are individually or collectively further operable to execute the code to cause the first network entity to:
transmit a second control message comprising a bit position of the second indication within the control message, wherein the bit position indicates that the second indication is included in a second information block of the plurality of information blocks.

20. The first network entity of claim 19, wherein the second information block comprises both of the second indication and a first indication of the discontinuous transmission configuration, the discontinuous reception configuration, or both for a second cell of the plurality of cells.

21. The first network entity of claim 19, wherein the second information block comprises a plurality of third indications providing a respective network energy savings mode associated with the plurality of cells, the plurality of third indications comprising at least the second indication indicating the network energy savings mode of a first cell.

22. The first network entity of claim 15, wherein the one or more processors are individually or collectively further operable to execute the code to cause the first network entity to:
transmit, via a second information block of the one or more information blocks, a third indication indicating a network energy savings mode of a second cell of the plurality of cells, wherein the second cell is a candidate target cell for the first UE and a primary cell for a second UE of the plurality of UEs.

23. The first network entity of claim 15, wherein the second indication comprises a plurality of bits, and a first bit of the plurality of bits indicates the network energy savings mode of the first cell and one or more second bits of the plurality of bits activate one or more respective conditional handover configurations for the first UE.

24. A method for wireless communications by a first user equipment (UE), comprising:
receiving a control message common to a plurality of UEs comprising at least the first UE, the control message comprising a plurality of information blocks corresponding to a plurality of cells, wherein:
one or more information blocks of the plurality of information blocks comprise one or more first indications providing a discontinuous transmission configuration, a discontinuous reception configuration, or both for one or more cells of the plurality of cells; and
at least a first information block of the plurality of information blocks comprises a second indication indicating a network energy savings mode of a first cell of the plurality of cells, the first cell comprising a primary cell for the first UE;
monitoring a wireless channel for a conditional handover execution condition based at least in part on the network energy savings mode of the primary cell indicated by the second indication; and
performing a conditional handover procedure based at least in part on monitoring for the conditional handover execution condition.

25. The method of claim 24, wherein monitoring the wireless channel for the conditional handover execution condition comprises:
monitoring for a first conditional handover execution condition based at least in part on the second indication indicating that the first cell operates in the network energy savings mode, the first conditional handover execution condition associated with the network energy savings mode; or
monitoring for a second conditional handover execution condition based at least in part on the second indication indicating that the first cell operates in a non-network energy savings mode, the second conditional handover execution condition associated with the non-network energy savings mode.

26. The method of claim 24, further comprising:
receiving, via the first information block, a first indication of the discontinuous transmission configuration, the discontinuous reception configuration, or both for the first cell, wherein the first information block comprises the second indication.

27. The method of claim 26, wherein the second indication is located in a second bit position that is after a first bit position corresponding to the first indication within the first information block.

28. The method of claim 26, wherein the second indication is located in a second bit position that is before a first bit position corresponding to the first indication within the first information block.

29. The method of claim 24, further comprising:
receiving a second control message comprising a bit position of the second indication within the control message, wherein the bit position indicates that the second indication is included in a second information block of the plurality of information blocks.

30. A method for wireless communications at a first network entity, comprising:
communicating with a second network entity to establish a conditional handover configuration for at least a first user equipment (UE); and
transmitting, to a plurality of UEs comprising at least the first UE, a common control message comprising a plurality of information blocks corresponding to a plurality of cells, wherein:
one or more information blocks of the plurality of information blocks comprise one or more first indications providing a discontinuous transmission configuration, a discontinuous reception configuration, or both for one or more cells of the plurality of cells; and
at least a first information block of the plurality of information blocks comprises a second indication indicating a network energy savings mode of a first cell of the plurality of cells, the first cell comprising a primary cell for the first UE.
